(19) United States
(12) Patent Application Publication
(10) Pub. No.: US 2009/0117923 A1
(43) Pub. Date: May 7, 2009

(54) On-Demand SMS-Based Traffic Reporting

(76) Inventors: Robert Edward Berger, Huntington Beach, CA (US); Jamie Lynn Berger, Huntington Beach, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 11/934,022

(22) Filed: Nov. 1, 2007

(51) Int. Cl. H04Q 7/20

(52) U.S. Cl. 455/466

(57) ABSTRACT

An SMS message can be received from a requesting device displaying a digital image of a region of interest that requests a traffic update, characterizes a region of interest and identifying a communications service provider associated with the requesting device. Thereafter, traffic information can be collected for the traffic region of interest. Once that traffic information is collected, a plurality of SMS messages can be sent that contain the traffic information to the requesting device via an SMS gateway associated with the communications service provider to enable a plurality of traffic designation points overlaid on the digital image of the region of interest to be displayed with the traffic information. Related systems, apparatus, methods, and/or articles are also described.

### TECHNICAL FIELD

The subject matter described herein relates to on-demand reporting of traffic using Short Message Service (SMS) messaging.

### BACKGROUND

Mobile phone usage is dramatically increasing as handsets are introduced into the marketplace with functionality beyond voice. New phones include video and camera capabilities, mp3 players, games, and numerous applications such as calendaring and contacts. In order to provide an interface for such features, handsets are including display screens with finer resolution. While the enhanced interfaces on phones combined with increased data transfer rates allow mobile phone users to surf the Internet, mobile phone carriers charge a significant premium for data consumption and accessing the Internet can be difficult using a limited keyboard provided on most handsets. Such difficulties can be compounded when the handset user is driving a vehicle or in some other situation that requires his or her full attention.

### SUMMARY

In one aspect, an SMS message (which also includes an Multimedia Message Service (MMS) message) requesting a traffic update can be received from a requesting device. This SMS message can include data that characterizes a region of interest and identifies a communications service provider associated with the requesting device. In response to the receipt of the SMS message, traffic information for the traffic region of interest can be collected. Once this traffic information is collected, at least one SMS messages containing the traffic information can be sent to the requesting device via an SMS gateway associated with the communications service provider to enable a plurality of traffic designation points overlaid on a digital image of the region of interest to be displayed with the traffic information.

The requesting device can be a mobile communications handset, a vehicle mounted computer (e.g., navigation system, etc.), a mobile computer, and the like.

In some implementations, an advertisement can be delivered to the handset for display prior to a traffic display, subsequent to a traffic display and/or displayed concurrently with a traffic display. Such an advertisement can also be sent via messaging.

The SMS gateway can be a gateway operated by the communications provider or other communication channel associated with the requesting device. In some variations, the SMS message further includes an identification code (e.g., telephone number, SIM card, etc.) identifying the mobile communications handset so that an account associated with the identification code can be invoiced based on a number of sent SMS messages containing the traffic information.

The collection of traffic information can include, polling a traffic server, by a messaging server, to obtain data characterizing traffic within the region of interest specified by the received SMS message. The traffic server can receive data from a plurality of remote servers (e.g., data sources). Additionally, the traffic server can encoded the traffic data, packetize the encoded traffic data, compress the packetized encoded traffic data, and transmit one or more SMS messages containing the compresses packetized encoded traffic data to the messaging server. The remote data sources can include, for example, roadway traffic speed sensors, roadway cameras, remote servers, and wireless transmitting data sources that are indicative of traffic conditions.

In some implementations, the SMS message requesting the traffic update can further characterize a version number of software installed on the requesting device. In such cases, the plurality of sent SMS messages can be generated to be compatible with the version number of the software installed on the requesting device.

The requesting device after receiving a plurality of SMS messages, decompresses the plurality of SMS messages, decodes the decompressed plurality of SMS messages and parses the decoded decompressed plurality of SMS messages.

In addition, as the requesting device receives periodic SMS messages each containing traffic updates, a visual representation of one or more of the plurality of traffic designation points overlaid on the digital image of the region of interest can be modified based on the content of the plurality of received SMS messages. In particular, subsets of the plurality of traffic designation points can be updated as individual sent SMS messages are received by the requesting device.

In some implementations, the traffic information within the received SMS message may contain incident information. In other implementations, an incident notification SMS message can be sent to the requesting device via the SMS gateway associated with the communications service provider. Such an incident notification SMS message can characterize a description and location of an incident to enable an incident designation point to be overlaid on the digital image of the region of interest at a point on the digital image corresponding to the location of the incident. The description of the incident can characterize a type of incident and a time of the incident.

In some implementations, a second SMS message can be received from the requesting device that requests a second traffic update and characterizes a second user-selected region of interest. Thereafter, traffic information for the second user-selected region of interest can be selected so that a second plurality of SMS messages containing the traffic information for the second user-selected region of interest can be sent to the requesting device via the SMS gateway to enable a plurality of second traffic designation points overlaid on the digital image of the second user-selected region of interest to be displayed with the traffic information.

In some variations, advertisements can be displayed on the requesting device and can be bundled within the received SMS messages (or sent via separate SMS message).

In order to allow for a one-touch refresh of the traffic information on the requesting device, in some implementations, the SMS message received from the requesting device can be generated in response to a user activating an application on the requesting device or by the user initiating a refresh operation.

If an SMS message from the requesting device is received, by, for example, a messaging server, indicating that one or more of the plurality of SMS message containing the traffic information was not received by the requesting device, then additional SMS messages containing the traffic information omitted from the previously sent plurality of SMS messages can be sent. In order to avoid double billing for such “repair” SMS messages, a message can be sent to a billing server indicating that an account associated with the requesting device should not be invoiced for the sent additional SMS messages.

In an interrelated aspect, a system can include a traffic server and a messaging server. The traffic server can be coupled to a plurality of data sources. The data sources can provide traffic information characterizing vehicle speeds in a region of interest and incident information characterizing a traffic incident and a location of the traffic incident. The traffic server can generate a plurality of SMS messages containing compressed packetized traffic information and incident information. The messaging server is in turn coupled to the traffic server and can receive the SMS messages generated by the traffic server. The messaging server can also be coupled to a communications network to receive SMS messages from requesting devices that each request a traffic update and characterize a region of interest and identify a communications service provider associated with the corresponding requesting device (which in turn can display a digital image of the region of interest). The messaging server can send a plurality of SMS messages containing the traffic information to each requesting device via an SMS gateway associated with the corresponding communications service provider to enable a plurality of traffic designation points overlaid on the digital image of the region of interest to be displayed with the traffic information.

In another interrelated aspect, an SMS message by a requesting device can request a traffic update, characterize a region of interest, and identify a communications service provider associated with the requesting device. Thereafter, a plurality of SMS messages containing traffic information for the region of interest can be received via an SMS gateway associated with the communications service provider so that a plurality of traffic designation points can be displayed overlaid on a digital image of the region of interest based on the received plurality of SMS messages.

In a further interrelated aspect, a plurality of SMS messages can be received from a requesting device each requesting a traffic update and characterizing one region of interest within a traffic zone comprising a plurality of regions of interest and identifying a communications service provider associated with the requesting device. Thereafter, traffic information for each traffic region of interest within the traffic zone can be collected which results in a plurality of SMS messages containing the traffic information being sent to the requesting device via an SMS gateway associated with the communications service provider to enable a plurality of traffic designation points overlaid on a digital image of each region of interest within the traffic to be displayed with the traffic information.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may encode one or more programs that cause the processor to perform one or more of the operations described herein.

The subject matter described herein provides many advantages. For example, traffic information can be easily and rapidly updated on the requesting device while consuming minimal bandwidth.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for providing a traffic update to a mobile device via SMS or MMS;

FIG. 2 is a diagram illustrating a system for delivering traffic updates to mobile devices via SMS or MMS;

FIG. 3A is an illustration of a map rendered on a mobile device indicating traffic conditions within a region of interest;

FIG. 3B is a legend for the map of FIG. 3A;

FIG. 4 is an example of text being sent along with traffic updates via SMS that can be used for emergency/Amber alerts or text advertisements.

FIG. 5 is an example of basic graphic that can be generated along with traffic updates via SMS that can be used to graphically enhance alerts or advertisements.

FIG. 6 is an example of custom graphic that can be generated along with traffic updates via SMS that can be used to graphically enhance alerts or advertisements.

Like reference symbols in the various drawings indicate like elements.

### DETAILED DESCRIPTION

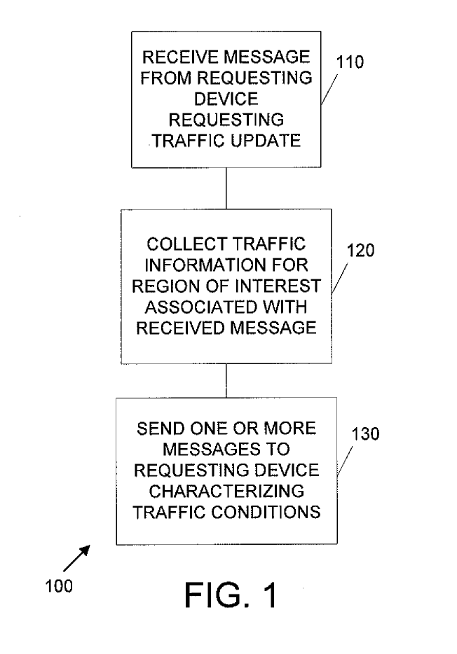

FIG. 1 is a process flow diagram illustrating a method 100 in which, an SMS messages is received, at 110, from a requesting device that requests a traffic update and characterizes (i.e., identifies, etc.) a region of interest. The SMS message can also identify a communications service provider associated with the requesting device. Thereafter, at 120, traffic information is collected for the traffic region of interest. Once such traffic information is collected, a plurality of SMS messages containing the traffic information is sent, at 130, to the requesting device via an SMS gateway associated with the communications service provider to enable a plurality of traffic designation points overlaid on a digital image of the region of interest to be displayed with the traffic information.

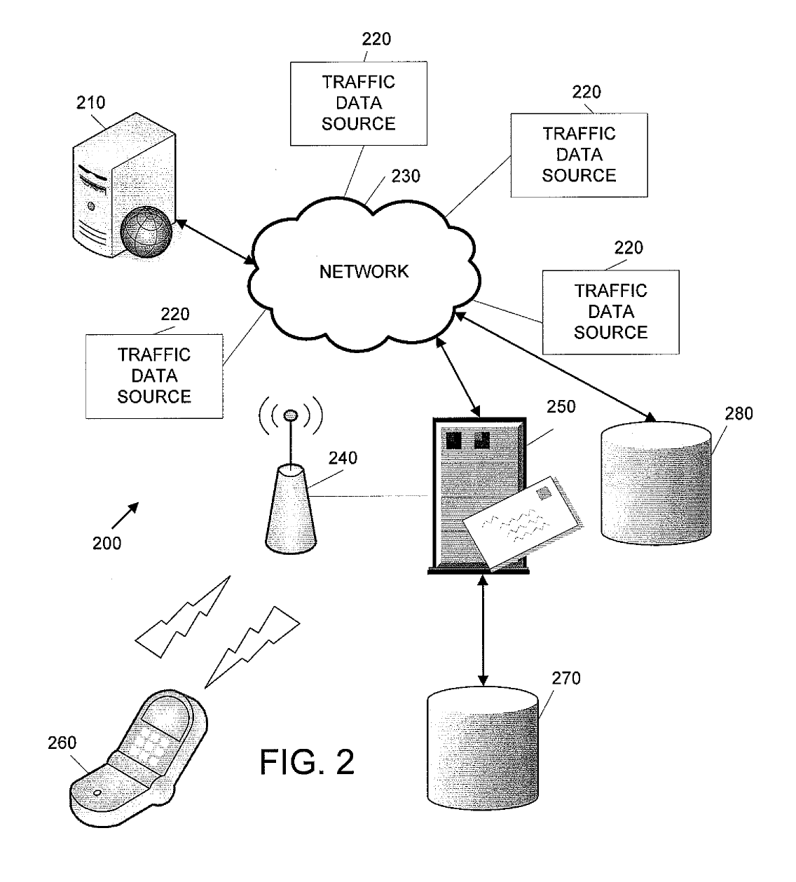

FIG. 2 is a diagram illustrating a system 200 that includes a traffic server 210 that is coupled to one or more traffic data sources 220 either directly or via a network 230. The traffic data sources 220 provide traffic information such as vehicle speeds in a region of interest and incident information such traffic incidents and locations of traffic incidents. In some variations, the traffic server 210 generates a plurality of SMS messages containing compressed packetized traffic information and incident information obtained from the traffic data sources 220. It will be appreciated that other messaging formats such as MMS may also be utilized depending on the desired configuration.

A messaging server 250 is coupled to the traffic server 210 either directly or via network 230. The messaging server 250 receives the packetized encoded and compressed message(s) generated by the traffic server 250. The messaging server 250 is also coupled to a wireless network 240 that is operable to be connected to a requesting device 260 (e.g., a mobile communications handset, a laptop computer, a vehicle mounted computing device, etc.). It will be appreciated that while the subject matter described herein describes an arrangement having a single requesting device 260, it will be appreciated that the traffic server 210 and/or the messaging server 250 can be configured to concurrently interact with a plurality of requesting devices 260.

The requesting device 260 may send SMS messages to the messaging server 250 via the wireless network 240 that each request a traffic update and characterize a region of interest. Such a request can also identify a communications service provider associated with the corresponding requesting device 260 (e.g., a mobile phone carrier, etc.). In response to receiving such a request, the messaging server 250 can send a plurality of SMS messages containing the traffic information (and in some implementations incident information) to the requesting device 260 via the wireless communications network 240. In some implementations, the SMS messages sent by the messaging server 250 can be sent via an SMS gateway associated with the communications service provider associated with the corresponding requesting device 260 (in order to minimize carrier-related charges for the account holder of the requesting device 260). Once the requesting device 260 receives the SMS messages from the messaging server 250, a plurality of traffic designation points overlaid on a digital image of the region of interest rendered on the requesting device 260 can be displayed with the traffic information.

The traffic data sources 220 can collect traffic information (including incident information) from a wide variety of sources such as roadway sensors, vehicular-mounted location sensors (e.g., GPS sensors), and/or cameras operated by the Department of Transportation (DOT), local municipalities, universities, private companies, and the like. The traffic server 210 can log into these traffic data sources 220 and obtain a data feed for traffic for one or more regions of interest (or other geographic areas). The traffic server 210 parses the data feeds for relevant information related to roadway velocity and/or volume. The traffic server 210 then encodes the information, packetizes the encoded message (i.e., breaks the message up into fragments because SMS only allows 150 characters per transmitted message and other formats have varying limits), compresses the encoded message(s) using a compression algorithm, and sends the message(s) downstream to the messaging server 250. Similar techniques can be incorporated for incident information originating from traffic data sources 220, and depending on the manner in which the incident information is reported, different encoding and/or compression schemes may be utilized.

One the traffic server 210 has the latest traffic packets available and the latest incidents packets available, the packets can be sent via, for example, TCP/IP over the network 230 to the messaging server 250. In some implementations, the messaging server resides locally to the traffic server 210 (e.g., an Intranet link couples the traffic server 210 to the messaging server 250). While FIG. 2 illustrates a single traffic server 210 and a single messaging server 250, it will be appreciated that multiple such servers can be utilized. As an example, multiple messaging servers 250 may be implemented in locations among a network that are closer in proximity to the wireless communications network 240 so that the path to the corresponding requesting device 260 is minimized.

The user of the requesting device 260 starts a traffic application installed on the requesting device 260, a regional map (that includes at least one region of interest can be displayed on a screen of the requesting device. Upon initialization of the traffic application, the requesting device can send a message via SMS over the wireless communications network 240 to the messaging server 240 requesting information for that particular region. Moreover, in some implementations the SMS message sent by the requesting device 260 can include information that can be used to identify a mobile communications provider (e.g., cell provider) so that carrier surcharges to the account holder of the requesting device 260 may be reduced.

The messaging server 250 accepts the update query SMS message from the requesting device 260, places the phone number of the requesting device 260, the requested region of interest, as well as a date and timestamp into a database 270 and then transmits the traffic and incident packets received from the traffic server 210 to the requesting device 260 via SMS on the wireless communications network 240. At this point, the traffic application waits for the incoming traffic and incident packets sent via SMS from the messaging server 250. The packets can arrive all at once or one at a time in order or out of order. If the packets arrive all at once, then the map can display traffic and incident information within one graphical update. If the packets do not arrive all at once, the packets can be reconstructed as they arrive. In this mode, during each packet reception, the traffic application map can be partially updated with information until all packets are received by the requesting device 260. If some packets do not arrive, the traffic application can initiate the transmission of an SMS message by the requesting device 260 to the messaging server 250 indicating that after a certain amount of time the traffic application did not receive all packets. Thereafter, the messaging server 250 can log that case and not charge the customer for the traffic information.

After initiating the traffic application on the requesting device 260, the user can select a region of interest (either by selecting a subsection of the region map or by using a GUI object (e.g., a drop down menu, etc.). After the region is selected, the traffic application causes the requesting device 260 to send an SMS message (which may be encoded/compressed) to the messaging server 250 with the selected traffic region of interest and one or more of an account holder identifier (e.g., cell phone number, IP address, etc.), a communications service provider (e.g., cell phone provider, etc.), and software version number. The messaging server 250 can then poll the traffic server 210 if it does not have updated packets for the region of interest and it can cause a log in the database 270 to be updated (for purposes such as billing). The messaging server 250 can also send packets back to the requesting device 260 to confirm receipt of the traffic update request and for related purposes.

In some implementations, an alert/advertisement database 280 can be coupled to the network 230. This alert/advertisement database 280 can be utilized in arrangements in which advertisements are bundled or otherwise delivered with traffic information. The database 280 contains a list of advertisers and alerts so that when an advertisement is sent out, the database will be time stamped as to when the advertisement was sent, to whom it was sent, and in some variations, the type of advertisement (i.e., text, graphics, low-bandwidth, high-bandwidth, etc.). In some implementations, messages requesting traffic updates may indicate whether a user has an account which is to include advertising or not (e.g., a user opting for discounted monthly rate could be required to view advertisements).

The first time the traffic application is launched by the user, a dialog box can appear asking them to select their cell phone provider. A listbox displays the providers and the user selects his or her cell phone provider. Such an arrangement can decrease costs because communications from/to the requesting device 260 and the messaging server 250 can be routed through a distinct gateway setup by the same carrier. For example, a user selects Verizon as their cell phone provider. This information is saved in traffic application and, thereafter, SMS message transfer can occur solely within the Verizon Network to reduce costs because “in network” communications costs less (free) than out of network communications. The traffic application can then store the carrier information and unless the requesting device 260 is assigned a new phone number (or a new SIM card is inserted into the requesting device 260).

When the user selects a region of interest for traffic, traffic application waits for message packets from the messaging server 250. As stated above, if all SMS messages containing packets of traffic information arrive sequentially within a predefined period of time, the traffic information contained within the packets can be used to update the region map with the traffic information for the entire region of interest. However, if the SMS messages are not received in a sequential fashion, the traffic application reconstructs each packet within the SMS messages as they arrive. When a packet arrives traffic application decompresses, decodes, parses the message and “turns on” traffic designation points (e.g., polygons, circles, lines, or any other visual mechanism to convey traffic conditions) on the screen.

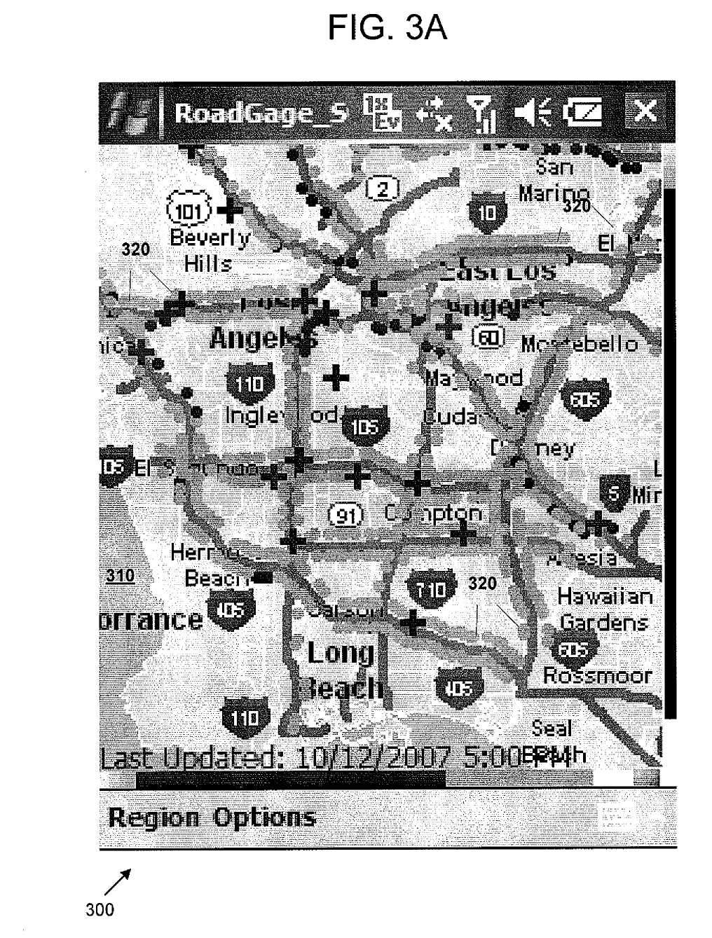

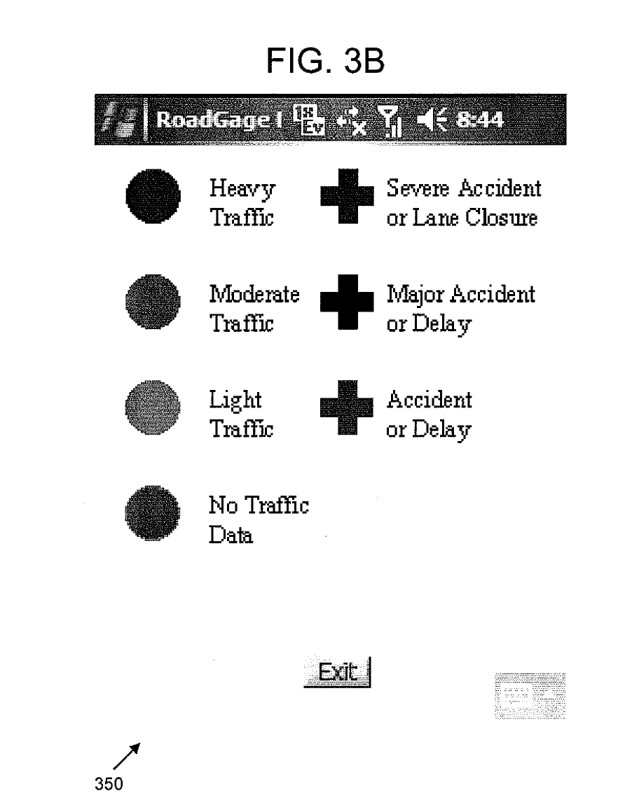

FIG. 3 is a sample view 300 of a regional map 310 in which a plurality of traffic designation points 320 are overlaid onto the map. If DOT road sensors or other static sensors are being used by the traffic data sources 220, the traffic application can maintain a localized database of road sensors. Each traffic packets is decompressed, decoded, parsed and compared to this local database of traffic designation points 320 (which correspond to the polygons, colored dots, etc.). With each incoming packet, after parsing, segments of this database are “turned on”; the partial updated database is used to update the regional map 310. When all packets arrive, the whole database is “turned on” and the regional map 310 gets updated again.

In some implementations, incident information can also be displayed on the regional map 310. While the traffic application uses static traffic designation points 320 to indicate traffic flow rates, the locations of incidents can be dynamic in nature and may occur at almost any location within the regional map 310. With packets containing incident information, the traffic application decompresses, decodes and parses incident information by dynamically creating an incident database upon receiving packets. If one packet arrives, traffic application parses information which yields the type of incident, incident time and location of incident (latitude and longitude). The type of incident can comprise a code which can be compared against a local traffic application database. For example, code 01 could stand for severe accident with ambulance responding, 02—major motorcycle accident, 03—debris on roadway, and the like. The packet is serviced and a traffic designation point 320 can be placed on the map of the location of incident based on latitude/longitude converted to graphical pixels. The incident for that packet is stored in a dynamic database. With each incident packet, the dynamic database grows until all incident packets have arrived.

In some implementations, traffic application can visually display a timestamp indicating that last time that the regional map 310 was updated. Additionally, some implementations allow the user to turn on (i.e., display) or turn off (i.e., hide) all or some of the traffic designation points 320 whether they relate to vehicular velocities or incidents.

In some cases, the granularity of the traffic designation points 320 on the regional map 310 may not reflect all of the possible traffic designation points 320 that may be displayed. For example, a user can zoom in on a portion of the map which might include a finer detail of particular roadways. In such cases, it may be necessary for the requesting device 260 to send a further SMS message that identifies the “zoomed-in” portion of the regional map 310 so that traffic designation points 320 within such portion that are not displayed in the previous “zoomed-out” portion of the regional map 310 can be populated with traffic information (i.e., vehicular speeds and incident information), or a finer granularity of traffic designation points 320 can be displayed. Alternatively, a “zoomed in” version of the regional map 310 may be stored on the mobile device so that the traffic designation points 320 may be activated on such zoomed-in version of the regional map 310.

The traffic application may also provide a plain text update of vehicular speeds and incidents with each traffic designation point 320 being characterized in text. Table I illustrates sample vehicle speeds along Interstate 5 traveling northbound in San Diego County. The color of the text can be altered to reflect vehicular speeds (e.g., green for clear, yellow for some congestion, and red for greatly reduced speeds, etc.).

TABLE 1

| 5 FREEWAY NORTHBOUND | SPEED |
|---|---|
| Harbor Dr | 53 mph |
| 76 | |
| Mission Ave | 58 mph |
| Oceanside Blvd | 54 mph |
| Cassidy St | 52 mph |
| Cannon Rd | 62 mph |
| Palomar Airport Rd | 58 mph |
| Poinsettia Ln | 58 mph |
| La Costa Ave | 64 mph |
| Leucadia Blvd | 60 mph |
| Manchester Ave | 65 mph |
| Lomas Santa Fe Dr | 51 mph |
| Via de la Valle | 24 mph |
| Del Mar Heights Rd | 62 mph |
| HOV @ Carmel Valley Rd | 75 mph |
| Bypass @ Carmel Valley Rd | 71 mph |
| Carmel Valley Rd | 66 mph |
| La Jolla Village Dr | 68 mph |
| Mission Bay Dr | 68 mph |
| Clairemont Dr | 59 mph |
| S/O Clairemont Dr | 69 mph |
| Sea World Dr | 64 mph |
| S/O 8 | no data |
| Old Town/Moore | 60 mph |
| S/O Old Town Ave | 66 mph |
| Wash/San Diego Ave | 60 mph |
| India St | 61 mph |
| Hawthorn St | 55 mph |
| N/O 163 | 56 mph |
| 94 WB Connector | 56 mph |

The traffic application can also be configured to allow for instant messages/pop-up messages to be displayed, such as Amber alerts, or a notification of an incident which has greatly reduced vehicle speeds. In addition, advertisements can be inserted or otherwise displayed in the traffic application and delivered by SMS message. Such advertisements can be displayed, for example, in order to subsidize the traffic reporting costs. The advertisements can be generated, for example, by using an alert/advertisement database 280 coupled to the network 230 that contains advertisement data, and which further can store, for example, information regarding transmitted advertisements.

Every time the user opts to refresh the traffic information, traffic application goes through the above sequence if they are still requesting the same region of interest. A dialog box can prompt the user that extra charges will apply and if they want to proceed. The user has the option turn off the dialog box warning forever by placing a check in the checkbox.

When the traffic information is refreshed, the traffic application does not clear the map and start over. Rather, the traffic application keeps the last traffic information and with each incoming packet, updates the previous “color coded” database and refreshes the traffic designation points 320 on the regional map 310. When all packets arrive, the previous “color coded” database is updated with all new color coded information. This database is then used to update the regional map 310 again. This arrangement can be implemented so that in cases in which all packets do not arrive, the previous traffic information with the partially updated new traffic information resides in the same database and the regional map 310 gets the “best” case traffic scenario. In other words, the static traffic database can be updated with each incoming traffic packet.

After the traffic is refreshed, the previous incident database can be used as a “base” database for incoming indents. When a new incident packet arrives, the “base” incident database is updated with the new incident. If the new packet has incident information already in the base database, the database gets overwritten. After each packet (from a refresh operation) the incident “base” database is used to update the regional map 320. When a new packet arrives (after a refresh operation), traffic application can also dynamically create a second incident database. This second incident database can be used to update all incidents on the map only after all packets have arrived. This arrangement can be implemented in case all packets do not arrive so that the previous incident database information can be updated with the partially updated new incident information resides in the same “base” database and the regional map 320 gets the “best” case incident scenario. In other words, two dynamically created databases can be used to update the regional map 310 with incident information. The base database can be used to update the regional map 310. After a refresh operation, the base database is still used for new packet arrivals with a second database dynamically created. The base database is used until all packets have arrived. Once all packets have arrived the second database is used to update the regional map 310. If the user elects to initiate another refresh operation within the same region of interest, this second database is used as the base database. The updating steps described above are then repeated.

As an example, if a user selects Orange County. A sequence such as that illustrated in FIG. 1 is performed. Traffic is time stamped at 4:00 p.m. User then selects Los Angeles. A sequence such as that illustrated in FIG. 1 is performed for Los Angeles. Traffic is time stamped at 4:30 p.m. Now user goes back to Orange County region. Orange County map shows traffic from the 4:00 p.m. updated. Only when the user selects REFRESH option, Orange County will update traffic with most recent results. User goes back to LA region. Map has LA traffic from 4:30 p.m. updates. Now user goes to San Diego map. Since the user has not been to the San Diego region, traffic application will send a message asking for traffic updates. In general, after starting traffic application, if the user goes to a region for the first time, traffic application requests traffic info without the user selecting the REFRESH option. If the user goes to a region where traffic was already updated, traffic application will keep the last traffic update and the user will need to select the REFRESH option in order to get more recent traffic info.

Below is an example of a traffic message encoded for the traffic application. For this particular example, it takes one traffic message to give all traffic information on an Orange County Map.

T1_{—}1 08/29/2006 15:35-D12

˜G′2D10′24403004′3002˜H′2D900104′0201′011001′020C′0105′188409′0280′0110′1018′0340′0140′1380′011E95DE′06088004′0140′2308′19408002′060140′05283 8˜K01˜O0′85′0′E2′0′0′˜˜A4

T1_{—}1 means this is traffic message 1 of 1. (If Orange County needed 3 traffic messages during rush hour this could be T1_{—}3 meaning traffic message 1 of 3; see second example.

08/29/2006 15:35 is the timestamp for the traffic information.

- is a separator between Timestamp and Region

D12 is the District/Area of traffic information. In this case it is D12 which is the Orange County Region. D3 is the Sacramento Region. D4 is the San Francisco Region. D7 is the Los Angeles Region. D8 is the San Bernardino Region. D11 is the San Diego Region, etc.

˜G means update all traffic designation points with RED Color or heavy traffic (0-19 mph).

The traffic designation points database can reside on the requesting device 260 (i.e., accompanying the traffic application are preferences and support files which include the traffic designation points). There can be a different traffic designation points database for each District/Area (e.g., region of interest, etc.).

This traffic designation points database may consist of 1 to x number of indices. Each index has information such as the x-y location on the map, distance to its nearest neighbor(s), angle to its nearest neighbor(s), etc. The index of the database starts at zero.

′SS is a 2-digit (8-bit) hexadecimal number meaning to start at SS×8 index within the traffic designation points database. (Note the accent character in front of any hex number SS).

So for the above message: ′2D means start at the first 45×8=360 index in the traffic designation points database. (Since 2D in hex=45 decimal). Now index 360 is being pointed at in the traffic designation points database.

XX is a 2-digit (8-bit) hexadecimal number following any ′SS hex digits. This XX hex number will look at the next 8 indices within the traffic designation points database.

So for the above message: 10 means for index 360 through 367 inclusive make index 364 in the database color RED (because 10 hex=16 decimal and a value of 16 is position 5 in an 8-bit binary logic from index 360). Now index 368 is being pointed at in the traffic designation points database.

′24 means start at the next 36×8=288 index (since 24 hex=36 decimal) from 368.

Now index 656 is being pointed at in the traffic designation points database (368+288=656).

40 means for index 656 through 663 inclusive make index 662 in the database color RED. (Since 40 hex=64 decimal and a value of 64 decimal is position 7 in an 8-bit binary logic from index 656). Now index 664 is being pointed at in the traffic designation points database.

30 means for index 664 through 671 inclusive make index 668 and index 669 in the database color RED (because 30 hex=48 decimal and a value of 48 are position 5 and 6 in an 8-bit binary logic from index 664). Now index 672 is being pointed at in the traffic designation points database.

04 means for index 672 through 679 inclusive make index 674 in the database color RED (because 04 hex=4 decimal and a value of 4 decimal is position 3 in an 8-bit binary logic from index 672). Now index 680 is being pointed at in the traffic designation points database.

′30 means start at the next 48×8=384 index (since 30 hex=48 decimal) from 680. Therefore, index 1064 is being pointed at in the traffic designation points database (384+680=1064).

02 means for index 1064 through 1071 inclusive make index 1065 in the database color RED (because 02 hex=2 decimal and a value of 2 decimal is position 2 in an 8-bit binary logic from index 1064).

˜H means that the traffic designation points database are going to be updated with the YELLOW color or moderate traffic (2140 mph). Again, go through the same iterative process as shown above. One can start at index 0 in the database, skip any index as defined, update indices with the YELLOW color, etc.

˜K means that the traffic designation points database are going to be updated with the GREY color or no traffic data. Again, go through the same iterative process as shown above. One can start at index 0 in the database, skip any index as defined, update indices with the GREY color, etc.

The traffic designation points database is defaulted to green colors. Therefore, the protocol does not need any sort of searches for green colors updating. From deduction, whatever is left over from red, yellow and grey is considered green.

˜O is the offset color pointer used to ensure the map coloring scheme is correct for multiple traffic messages. The information that follows is 2-digits (8-bit) hexadecimal numbers which give last offset pointers for each color. This is used to track where the color pointer was last pointed to in the traffic designation points database if there was more than one message.

0′85 means the RED color pointer is pointing at index 133×8=1064 in the current message (85 hex=133 decimal)

0′E2 means the YELLOW color pointer is pointing at index 226×8=1808 in the current message (E2 hex=226 decimal).

′0′0 means the GREY color pointer is pointing at index 0×8=0. (0 hex=0 decimal) in the current message.

As there was only one message the above explanation is not exciting. The second example will give more clarity.

˜˜A4 is the checksum of the message minus the header. In other words, from ˜G all the way to ˜˜ in the message:

G′21D10′24403004′3002˜H2D900104′0201′01 1001′020C′0105′188409′0280′0110′ 1018′0340′0140′1380′011E95DE′06088004′0140′2308′19408002′060140′05283 8˜K010˜O0′85′0′E2′0′0˜˜

There are 164 characters from ˜G through ˜˜ so A4 hex=164 decimal.

To better understand the ˜O sequence of numbers, consider this three part message taken from LA County traffic:

T1_{—}3 02/23/2007 16:35-D7

˜G′0410′0208′0108′0108′038002′0201′0409′0604′040401′01C004′07E4′0A20 50084102′052020′0520162709′030430′0188′014404′0203′050102′0180′0310′040108′0B20′01F83F0920′0102′010402′010E′0401′030108′0180′0190′0214′0411′028001′04 08′0104˜H390101′01055041222420681042498141˜O0′A8′0′F′0′0′˜˜114

T2_{—}3 02/23/2007 16:35-D7

FC9FA508A001800222′0260961815415B′0320′0213B8661A08′02A8AA1B0C 64374002′0148′0308AA2788′0102′0104401108961F4905′03E9D8564104193040′0104 4403CB0E85309981101C0550E55168′02828120′02B802100371′03025002′06C076˜O 0′0′F′7F′0′0˜˜DB

T3_{—}3 02/23/2007 16:35-D7

4201′01110208′0101′028067422002C0462308′01AA6C8360084002′013008CC 05′0118′010C′02200202′0109010240021C16˜K′5520′1109′3308˜O0′0′7F′B0′0′9B˜˜8B

In the first message look at ˜O0A8′0′F0′0′. The first pair of 2-dight hex numbers (0'A8′) are for RED dots, the next two pairs are (0′F′) for YELLOW dots and the final two pairs (0′0′) are for GREY dots.

0′A8′ means RED is currently pointing at index 7F hex or 127×8=1016 within the traffic designation points database.

0′F′YELLOW is at F hex or 15 dec×8=120 index.

0′0′ GREY is at 0 hex or 0 dec×8=0 index. In other words, no GREY dot analysis embodied within the message.

In the second message look at ˜O0′0′F′7F′0′0

0′0′ RED is at 0 hex or 0 dec×8=0 index. In other words, no RED dot analysis embodied within the message.

F′7F′ means start at index (F hex or 15 decimal×8)=120 and currently count from there. After counting through the message YELLOW is currently pointing at index 7F hex or 127×8=1016 within the traffic designation points database.

0′0 GREY is at 0 hex or 0 dec×8=0 index. In other words, no GREY dot analysis embodied within the message.

In the third message look at ˜O0′0′7F′B0′0′9B′

0′0′ RED is at 0 hex or 0 dec×8=0 index. In other words, no RED dot analysis embodied within the message.

7F′B0′ means start at index (7F hex or 127 decimal×8)=1016 and currently count from there. After counting through the message YELLOW is currently pointing at index b0 hex or 176×8=1408 within the traffic designation points database.

0′9B′ means GREY is currently pointing at index 9B hex or 127×8=1240 within the traffic designation points database.

As an example of how traffic messages can be compressed, reference is made to this first encoded message:

T1_{—}1 08/29/2006 15:35-D12

˜G′2D10′24403004′3002˜H2D900104′0201′011001′020C′0105′188409′0280′0110′1018′0340′0140′1380′011E95DE′06088004′0140′2308′19408002′060140′05283 8˜K01˜O0′85′0′E2′0′0′˜˜A4

This message can be compressed using a scan and replace all algorithm with conversion codes.

To use the conversion codes, a search and replace all algorithm can be used. The message is completely scanned for all matches on the left side of the conversion codes and replaced with the character on the right side of the conversion codes. An iterative process occurs whereby after replacing at least one match of the original message with the first conversion code line (assuming there was at least one match), the next conversion code is searched against and the scan and replace all algorithm is formed again. The cycle repeats itself until all conversion codes have been executed.

For example, to compress the header T1_{—}1 08/29/2006 15:35-D12 use the conversion codes:

| | |
|---|---|
| T1_{—} | { |
| I1_{—} | } |
| A1_{—} | , |
| B1_{—} | ! |
| E1_{—} | \grave{ } |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| 26/20 | ' |
| 27/20 | S |
| 28/20 | R |
| 29/20 | Q |
| 30/20 | P |
| 31/20 | O |
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| -D3 | & |
| -D4 | % |
| -D7 | $ |
| -D8 | # |
| -D11 | ″ |
| -D12 | \| |

So the header becomes: {1sQ06C35|

The body

### ˜G′2D10′24403004′3002˜H′2D900104′0201′011001′020C′0105′188409′0280′01 10′1 018′0340′0140′1380′011E95DE′06088004′0140′2308′19408002′060140′052838˜K01˜O0′85′0′E2′0′0′˜˜

needs its own set of conversion codes:

| | |
|---|---|
| 0\grave{ }0\grave{ }0\grave{ }0\grave{ } | { |
| 0\grave{ }0\grave{ }0\grave{ } | } |
| ~O0\grave{ } | \| |
| 0\grave{ }0\grave{ } | z |
| \grave{ }01 | y |
| \grave{ }02 | x |
| \grave{ }03 | w |
| \grave{ }04 | v |
| \grave{ }05 | u |
| \grave{ }06 | t |
| \grave{ }07 | s |
| \grave{ }08 | r |
| \grave{ }09 | q |
| \grave{ }0A | p |
| \grave{ }0B | o |
| \grave{ }0C | n |
| \grave{ }0D | m |
| \grave{ }0E | l |
| \grave{ }0F | k |
| \grave{ }10 | j |
| \grave{ }20 | i |
| \grave{ }40 | h |
| \grave{ }80 | g |
| ~~0 | f |
| ~~1 | e |
| ~~2 | d |
| ~~3 | c |
| ~~4 | b |
| ~~5 | a |
| ~~6 | _{—} |
| ~~7 | \hat{ } |
| ~~8 | ] |
| ~~9 | \ |
| ~~A | [ |
| ~~B | Z |
| ~~C | Y |
| ~~D | X |
| ~~E | W |
| ~~F | V |
| 01 | U |
| 02 | T |
| 03 | S |
| 04 | R |
| 05 | Q |
| 06 | P |
| 07 | O |
| 08 | N |
| 09 | M |
| 0A | L |
| 0B | K |
| 0C | J |
| 0D | I |
| 0E | H |
| 0F | G |
| 10 | @ |
| 20 | ? |
| 40 | > |
| 80 | < |
| 0\grave{ } | ; |
| 11 | : |
| 12 | / |
| 13 | . |
| 14 | - |
| 15 | , |
| 16 | + |
| 17 | * |
| 18 | ) |
| 19 | ( |
| 1A | ' |
| 1B | & |
| 1C | % |
| ~K | $ |
| ~G | # |
| ~H | ″ |
| ~O | ! |

So the message body gets converted to:

#2D@′244S0R′30T″′2D90URxUy@UxJyQ′)84Mx<y@j)w>y>′.<y1E95DEtN<Ry>′23N′(4N0TtU>u2838$U|85′;E2z[8

To summarize, the whole traffic message that is sent via SMS is:

{1sQ06C35|

#′2D@′244S0R′30T″′2D90URxUy@UxJyQ′)84Mx<y@j)w>y>′.<y1E95DEt N<Ry>′23N′(4N0TtU>ti2838$U|85′;E2′z˜.4[8

Note this message has ASCII characters only. Most SMS networks do not accept special characters. However, modifications can be made for SMS networks that have adopted special characters and for MMS networks.

An example conversion to decompress the header of the traffic message {1sQ06C35| is:

| | |
|---|---|
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| 26/20 | ' |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| T1_{—} | { |
| 27/20 | S |
| 28/20 | R |
| 29/20 | Q |
| 30/20 | P |
| 31/20 | O |
| I1_{—} | } |
| A1_{—} | , |
| B1_{—} | ! |
| E1_{—} | \grave{ } |
| -D3 | & |
| -D4 | % |
| -D7 | $ |
| -D8 | # |
| -D11 | ″ |
| -D12 | \| |

Use the following conversion codes to decompress the body

#′2D@′244S0R′30T″′2D90URxUy@UxJyQ′)84Mx<y@j)w>y>′.<y1E9SDEtN<Ry>′23N′(4N0TtU>u2838$U|85′;E2′z[8

| | |
|---|---|
| 0F | G |
| 0E | H |
| 0B | K |
| 07 | O |
| ~G | # |
| ~H | ″ |
| ~K | $ |
| ~O | ! |
| \grave{ }01 | y |
| \grave{ }02 | x |
| \grave{ }03 | w |
| \grave{ }04 | v |
| \grave{ }05 | u |
| \grave{ }06 | t |
| \grave{ }07 | s |
| \grave{ }08 | r |
| \grave{ }09 | q |
| \grave{ }0A | p |
| \grave{ }0B | o |
| \grave{ }0C | n |
| \grave{ }0D | m |
| \grave{ }0E | l |
| \grave{ }0F | k |
| \grave{ }10 | j |
| \grave{ }20 | i |
| \grave{ }40 | h |
| \grave{ }80 | g |
| 0\grave{ }0\grave{ }0\grave{ }0\grave{ } | { |
| 0\grave{ }0\grave{ }0\grave{ } | } |
| ~O0\grave{ } | \| |
| 0\grave{ }0\grave{ } | z |
| ~~0 | f |
| ~~1 | e |
| ~~2 | d |
| ~~3 | c |
| ~~4 | b |
| ~~5 | a |
| ~~6 | _{—} |
| ~~7 | \hat{ } |
| ~~8 | ] |
| ~~9 | \ |
| ~~A | [ |
| ~~B | Z |
| ~~C | Y |
| ~~D | X |
| ~~E | W |
| ~~F | V |
| 01 | U |
| 02 | T |
| 03 | S |
| 04 | R |
| 05 | Q |
| 06 | P |
| 08 | N |
| 09 | M |
| 0A | L |
| 0C | J |
| 0D | I |
| 10 | @ |
| 20 | ? |
| 40 | > |
| 80 | < |
| 0\grave{ } | ; |
| 11 | : |
| 12 | / |
| 13 | . |
| 14 | - |
| 15 | , |
| 16 | + |
| 17 | * |
| 18 | ) |
| 19 | ( |
| 1A | ' |
| 1B | & |
| 1C | % |

The complete message is reconstructed as:

T1_{—}1 08/29/2006 15:35-D12

˜G′2D10′24403004′3002˜H′2D900104′0201′011001′020C′0105′188409′0280′0110′1018′0340′0140′1380′011E95DE′06088004′0140′2308′19408002′060140′05283 8˜K01˜O0′85′0′E2′0′0′˜˜

Once traffic application decompresses the traffic message, traffic application parses the message to update the traffic designation points database with corresponding colors. The traffic application uses map(s) and database(s) resident on the requesting device in order update traffic. The map and database work in conjunction to give the illusion that the whole map and dots are being transmitted via SMS. However, the message only contains traffic designation points pointers to the traffic application client side database.

Incident designation points can also require encoding. Below is a sample incident message taken from LA County:

I1_{—}3 08/29/2006 15:33-D7

5FD102116A897605D65′5FC082812EC97C04A58′5FC002203C577609AE0′5FA0321156097604B5F′5F703211553276003FD′5F506220ACB5760ED70′5F2082115 54176053C3′5F00821164A2760465E′5EC0822017DE7604091′5E˜˜B8

I2_{—}3 08/29/2006 15:33-D7

A03220314575165D5′5EA0D220279F7604E54′5E9082201A8C7605CF3′5E80 422021B076053C7′5E7082200CF3760566A′5E6042207D51760C1EA′5DE0821139B 57601FF1′5A603220093D7512D1E′5A1032203BD97608F92′59E032205676760B8D˜˜C6

I3_{—}3 08/29/2006 15:33-D7

1′54F082201 B6A75151 BA′5460422014C876000D7′4C1022203E76760B75F′4BA0821155DE7604B80′22E11822094E0760A17C′˜˜68

I1_{—}3 means this is traffic message 1 of 3. (If LA County needed 1 traffic message during light traffic hours this could be T1_{—}1 meaning traffic message 1 of 1).

08/29/2006 15:33 is the timestamp for the traffic information.

- is a separator between Timestamp and Region

D7 is the District/Area of traffic information. In this case it is D7 which is the LA Region. D3 is the Sacramento Region. D4 is the San Francisco Region. D12 is the OC Region. D8 is the San Bernardino Region. D11 is the San Diego Region. Etc.

5FD102116A897605D65′ is one encoded incident. To break it down further;

5FD is the time the incident occurred. This is a 3-digit hexadecimal number 5FD hex=1533 decimal=1533 military time.

10 is a 2-digit hexadecimal incident code. 10 hex=16 decimal. So the software goes to index 16 in the incident database and selects that text for display. Moreover, the incident database is sorted from minor incidents to major incidents. The incident database is located on the requesting device hardware. The database looks somewhat like this:

Traffic Collision—Ambulance Responding

Traffic Collision—Major Injuries

Traffic Collision—Minor Injuries

Traffic Collision—No Injuries

Traffic Collision—No Details

Possible Fatality

Hit and Run—No Injuries

Hit and Run—Injuries

Traffic Hazard

Traffic Hazard—Hazard for Motorcycles

Traffic Hazard—Vehicle in Center Divider

Traffic Hazard—Large Object

Traffic Hazard—Debris/Objects

Traffic Hazard—Vehicle

Traffic Hazard—Animal

Traffic Hazard—Loose Animal

Traffic Hazard—Pedestrian on Freeway

Wrong Way Driver

Roadway Flooding

Mud, Dirt or Rock Slide

Weather Conditions

Advise of Road or Weather conditions

Wind Advisory

Wind Warnings

Structure or Grass Fire

Vehicle Fire

Report of Fire

Hazardous Materials Spill

Hazardous Material

Cargo or Hazardous Material Spill

Animal on Road

Lane Closure

SigAlert—Lane Closure

Closure of a Road

Disabled Vehicle

Animal in Traffic

Pedestrian on the Roadway

Pedestrian on a Highway

Pedestrian down—Unknown Details

Attempt Suicide—Jumping from Bridge

Attempt Suicide—Jumping from Bridge, O/C

Attempted Suicide

Traffic Advisory

Defective Traffic Signals

Media Info

Request for Traffic Break

Media Information

Caltrans Service Request for Notification

Traffic Control

Traffic Break Requested

Tow Truck

Traffic Hazard—Debris/Object

Weather Condition

Defective Traffic Signal

Mud, Dirt or Rock Slides

Vehicle Struck by Rocks from Truck

Attempted Suicide—Jumping from Bridge

So code 10 hex=Traffic Hazard—Loose Animal (16^{th} index in decimal; start counting from zero)

2116A89 is a 7-digit hexadecimal number for the latitude. 2116A89 hex=34695817 decimal or latitude 34.695817.

7605D65 is a 7-digit hexadecimal number for the longitude. 7605D65 hex=123755877 decimal or longitude −1223.755877 if one is west of prime meridian. For Asian traffic application this would be positive.

′ is the separator between incidents.

There are no offsets to worry about with incident messages. The Traffic/Incident Server takes care of the parsing in order to ensure a message ends with a (19-digit hex number) whole incident attached.

˜˜B8 is the checksum from

5FD102116A897605D65′5FC082812EC97C04A58′5FC002203C577609AE0′5FA0321156097604B5F′5F703211553276003FD′5F506220ACB5760ED70′SF2082115 54176053C3′5F00821164A2760465E′5EC0822017DE7604091′5E˜˜

There are 184 characters after the header to the ˜˜

Incident message 2 of 3 can be compress as follows:

I2_{—}3 08/29/2006 15:33-D7

A03220314575165D5′5EA0D220279F7604E54′5E9082201A8C7605CF3′5E80 422021B076053C7′5E7082200CF3760566A′5E6042207D51760C1EA′5DE0821139B 57601FF1′5A603220093D7512D1E′5A1032203BD97608F92′59E032205676760B8D˜˜C6

First the header I2_{—}3 08/29/2006 15:33-D7 using the conversion codes:

| | |
|---|---|
| T1_{—} | { |
| I1_{—} | } |
| A1_{—} | , |
| B1_{—} | ! |
| E1_{—} | \grave{ } |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| 26/20 | ' |
| 27/20 | S |
| 28/20 | R |
| 29/20 | Q |
| 30/20 | P |
| 31/20 | O |
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| -D3 | & |
| -D4 | % |
| -D7 | $ |
| -D8 | # |
| -D11 | ″ |
| -D12 | \| |

The header becomes T2_{—}2sQ06C20$

The body can be compressed

A013220314575165D5′5EA0D220279F7604E54′5E9082201 A8C7605CF3′5E80422021B076053C7′5E7082200CF3760566A′5E6042207D51760C1EA′5DE0821139B57601F F1′5A603220093D7512D1E′5A1032203BD97608F92′59E032205676760B8D˜˜C6

using the conversion codes

| | |
|---|---|
| \grave{ }1 | ! |
| \grave{ }2 | ″ |
| \grave{ }3 | # |
| \grave{ }4 | $ |
| \grave{ }5 | % |
| \grave{ }6 | & |
| \grave{ }7 | ′ |
| \grave{ }8 | ( |
| \grave{ }9 | ) |
| 00 | * |
| 01 | + |
| 02 | , |
| 03 | - |
| 04 | . |
| 05 | / |
| 06 | : |
| 07 | ; |
| 08 | < |
| 09 | > |
| 0A | ? |
| 0B | @ |
| 0C | G |
| 0D | H |
| 0E | I |
| 0F | J |
| 10 | K |
| 11 | L |
| 12 | M |
| 13 | N |
| 14 | O |
| 15 | P |
| 16 | Q |
| 17 | R |
| 18 | S |
| 19 | T |
| 1A | U |
| 1B | V |
| 1C | W |
| 1D | X |
| 1E | Y |
| 1F | Z |
| 20 | [ |
| 21 | \ |
| 22 | ] |
| 23 | \hat{ } |
| 24 | _{—} |
| 25 | a |
| 26 | b |
| 27 | c |
| 28 | d |
| 29 | e |
| 2A | f |
| 2B | g |
| 2C | h |
| 2D | i |
| 2E | j |
| 2F | k |
| 30 | l |
| 31 | m |
| 32 | n |
| 33 | o |
| 34 | p |
| 35 | q |
| 36 | r |
| 37 | s |
| 38 | t |
| ~~B | u |
| ~~ | v |
| 74 | w |
| 75 | x |
| 76 | y |
| 77 | z |
| 78 | \| |
| 79 | } |
| 7A | { |

The body becomes:

A-|-

O5xQ5D5%EAH],}Fy.E54%.E9<]+A8Cy/CF3%E8.],V;6/3C7% E7<]*CFs6/66A%E 6.];D5R6GYA%DE<2L39B5y+FF1%A6-|*93DxMDY%A1-|-BD9y<F92%9E-]/6yy@8DvC6

So the whole compressed incident message 2 of 3 that gets sent via SMS:

T2_{—}2sQ06C20$

A-|-

O5xQ5D5%EAH],}Fy.E54% E9<1+A8Cy/CF3%E8.],V;6/3C7%E7<]*CFs6/66A%E 6.]D5R6GYA%DE<2L39B5y+FF1%A6-|*93DxMDY%A1-|-BD9y<F92%9E-]/6yy@8DvC6

Note this message has ASCII characters only. Most SMS networks do not accept special characters. However, special characters can be adopted for SMS networks supporting such characters and for MMS networks.

The incident message can be decompressed starting by using the following conversion to decompress the header T2_{—}2sQ06C20$

| | |
|---|---|
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| 26/20 | ′ |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| T1_{—} | { |
| 27/20 | S |
| 28/20 | R |
| 29/20 | Q |
| 30/20 | P |
| 31/20 | O |
| I1_{—} | } |
| A1_{—} | , |
| B1_{—} | ! |
| E1_{—} | \grave{ } |
| -D3 | & |
| -D4 | % |
| -D7 | $ |
| -D8 | # |
| -D11 | ″ |
| -D12 | \| |

Use the following conversion codes to decompress the body

A-|-

O5xQ5D5%EAH],}Fy.E54%E9<]+A8Cy/CF3%E8.],V;6/3C7%E7<]*CFs6/66A%E 6.];D5R6GYA%DE<2L39B5y+FF1%A6-]*93DxMDY%A1-]-BD9y<F92%9E-]/6yy@8DvC6

The complete message is reconstructed as:

I2_{—}3 08/29/2006 15:33-D7

A03220314575165D5′5EA0D220279F7604E54′5E9082201A8C7605CF3′5E80 422021B076053C7′5E7082200CF3760566A′5E6042207D51760C1EA′5DE0821139B 57601FF1′5A603220093D7512D1E′5A 1032203BD97608F92′59E032205676760B8D˜˜C6

Once traffic application decompresses the incident message, traffic application parses the message to search for the incident type within the incident database. Traffic application uses a map and incident database resident on the requesting device in color lookup the type of incident. The messages give latitude and longitude coordinates for the map and color-code incidents polygons which are graphically display.

For advertising and or text alerts, the server can send a combination of text and graphics or both. As an example, a text message protocol can be utilized as listed in the table 2 below.

TABLE 2

| Parameter Name | Bytes | Range (Hex) | Comment |
|---|---|---|---|
| Desired Font | 1 | 0 to 3 | |
| X Origin | 3 | 000 to FFF | |
| Y Origin | 3 | 000 to FFF | |
| Text Color | 6 | 000000 to FFFFFF | Start Header Block |
| Background Text Color | 6 | 000000 to FFFFFF | |
| Horizontal Alignment | 1 | 0 to 2 | |
| Vertical Alignment | 1 | 0 to 2 | |
| Text Orientation | 1 | 0 to 3 | |
| Strikeout (only if Desired Font = 0) | 1 | 0 to 1 | |
| Italic (only if Desired Font = 0) | 1 | 0 to 1 | |
| Underline (only if Desired Font = 0) | 1 | 0 to 1 | |
| Outline (only if Desired Font = 0) | 1 | 0 to 1 | |
| Shadow (only if Desired Font = 0) | 1 | 0 to 1 | |
| Bold (only if Desired Font = 0) | 1 | 0 to 1 | |
| Size (only if Desired Font = 0) | 3 | 000 to FFF | |
| Font Name (only if Desired Font = 0) | Variable | | Text Block |
| Separator (to separate header &text | ~ | | |
| “blocks”) | | | |
| Text Message | Variable | | Text Block |
| | Checksum | | |
| ~~ | Separator | 000 to FFF | |

Desired Font=0 is user-specified font (e.g Arial, Times New Roman, etc)

Desired Font=1 is application font

Desired Font=2 is system font

Desired Font=3 is dialog font

X origin is the x coordinate the text would start on the screen.

Y origin is the y coordinate the text would start on the screen.

Text Color is the text color using the RGB color scheme (this could be other color schemes as well)

Background Text Color is the text color using the RGB color scheme (this could be other color schemes as well)

Horizontal Alignment=0 is left alignment

Horizontal Alignment=1 is center alignment

Horizontal Alignment=2 is right alignment

Vertical Alignment=0 is top alignment

Vertical Alignment=1 is center alignment

Vertical Alignment=2 is bottom alignment

Text Orientation=0 is none

Text Orientation=1 is stacked

Text Orientation=2 is clockwise

Text Orientation=3 is counterclockwise

Strikeout (only if Desired Font=0)=0 is no

Strikeout (only if Desired Font=0)=1 is yes

Italic (only if Desired Font=0)=0 is no

Italic (only if Desired Font=0)=1 is yes

Underline (only if Desired Font=0)=0 is no

Underline (only if Desired Font=0)=1 is yes

Outline (only if Desired Font=0)=0 is no

Outline (only if Desired Font=0)=1 is yes

Shadow (only if Desired Font=0)=0 is no

Shadow (only if Desired Font=0)=1 is yes

Bold (only if Desired Font=0)=0 is no

Bold (only if Desired Font=0)=1 is yes

Size (only if Desired Font=0)=0 is the font size

Font Name (only if Desired Font=0) is the font name

Separator (to separate header & text “blocks”); this denotes the start of the text to be sent.

Text Message is the message generated from the server and sent to RoadGage users.

˜˜ is the checksum separator

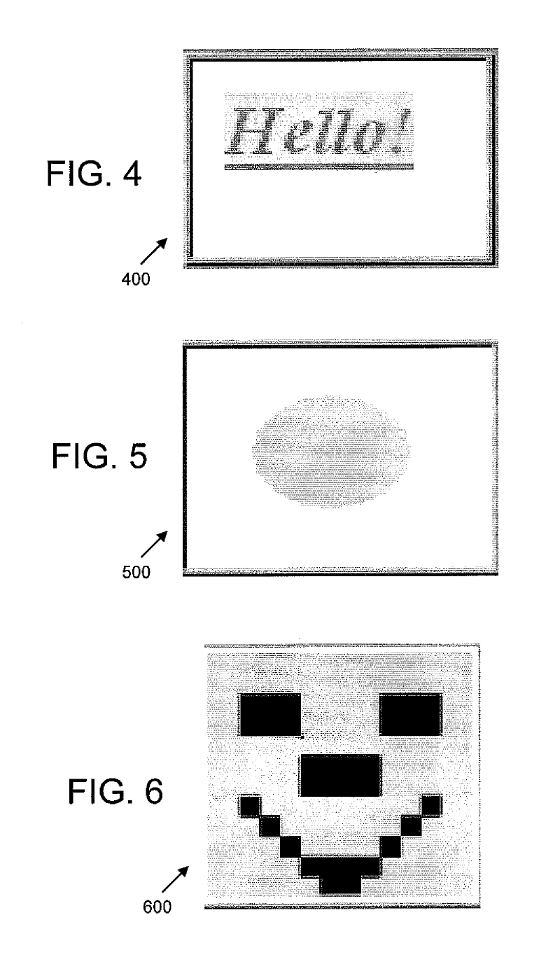

For example, if the screen received a text like that illustrated in the screenshot 400 of FIG. 4.

The parameters would be:

Desired Font=0

X Origin=A

Y Origin=A

Text color=C8B800

Background Text Color=CDF4E9

Horizontal Alignment=0

Vertical Alignment=0

Text Orientation=0

Strikeout (only if Desired Font=0)=0

Italic (only if Desired Font=0)=1

Underline (only if Desired Font=0)=1

Outline (only if Desired Font=0)=0

Shadow (only if Desired Font=0)=0

Bold (only if Desired Font=0)=1

Size (only if Desired Font=0)=01A

Font Name (only if Desired Font=0)=TIMES NEW ROMAN

˜

Hello!

˜˜

Therefore, the actual message encoded on the server would be:

E1_{—}1 08/29/2006 15:35-D12

0AAC8B800CDF4E900001100101ATIMES NEW ROMAN˜Hello!˜˜33

where 33 is the checksum value of the line

0AAC8B800CDF4E900001100101ATIMES NEW ROMAN˜Hello!˜˜

E1_means this is text message 1 of 1. (If Orange County needed 3 text messages this could be E1_{—}3 meaning text message 1 of 3).

08/29/2006 15:35 is the timestamp for the text information.

- is a separator between Timestamp and Region

D12 is the District/Area of traffic information. In this case it is D12 whicl iis the Orange County Region. D3 is the Sacramento Region. D4 is the San Francisco Region. D7 is the Los Angeles Region. D8 is the San Bernardino Region. D11 is the San Diego Region, etc.

Within the encoded message, the header E1_{—}1 08/29/2006 15:35-D12 can be compressed using the following conversion codes:

| | |
|---|---|
| T1_{—} | { |
| I1_{—} | } |
| A1_{—} | , |
| B1_{—} | ! |
| E1_{—} | \grave{ } |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| 26/20 | ′ |
| 27/20 | S |
| 28/20 | R |
| 29/20 | Q |
| 30/20 | P |
| 31/20 | O |
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| -D3 | & |
| -D4 | % |
| -D7 | $ |
| -D8 | # |
| -D11 | ″ |
| -D12 | \| |

So the header becomes:

′1sQ06C35|

Thus, the compressed message sent from the server to users would be:

′1sQ06C35|

′0AAC8B800CDF4E900001100101ATIMES NEW ROMAN˜Hello!˜˜33

When the user(s) receives the packet(s), the software decompresses the header using the following conversion codes:

| | |
|---|---|
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| 26/20 | ′ |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| T1_{—} | { |
| 27/20 | S |
| 28/20 | R |
| 29/20 | Q |
| 30/20 | P |
| 31/20 | O |
| I1_{—} | } |
| A1_{—} | , |
| B1_{—} | ! |
| E1_{—} | \grave{ } |
| -D3 | & |
| -D4 | % |
| -D7 | $ |
| -D8 | # |
| -D11 | ″ |
| -D12 | \| |

Thus, the header ′1sQ06C35| becomes:

E1_{—}1 08/29/2006 15:35-D12

In some variations, the encoded message body can be compressed or decompressed while sending the text protocol.

The background graphic protocol is listed below in Table 3.

TABLE 3

| Parameter Name | Bytes | Range (Hex) | Comment |
|---|---|---|---|
| Draw Function | 1 | 0 to 8 | 0 = Point; 1 = Line; 2 = Multi- |
| | | | Line; 3 = Rect; 4 = Gray-Rect; |
| | | | 5 = Round-Rect; 6 = Circle; 7 = Oval; 8 = Arc |
| Color | 6 | 000000 to | |
| | | FFFFFF | |
| Width | 3 | 000 to FFF | |
| Style | 1 | 0 to 4 | |
| End X (Draw Function = 0, 1) | 3 | 000 to FFF | |
| End Y (Draw Function = 0, 1) | 3 | 000 to FFF | |
| Absolute Coordinates (Draw | 1 | 0 to 1 | |
| Function = 1) | | | |
| End Xn (Draw Function = 2) | 3/line | 000 to FFF | |
| ~ | 1 | | Separartes X-Y Line Coordinates |
| End Yn (Draw Function = 2) | 3/line | 000 to FFF | |
| Fill (Draw Function = 2, 3, 5, 6, 7, 8) | 1 | 0 to 1 | |
| Left (Draw Function = 3, 4, 5, 7, 8) | 3 | 000 to FFF | |
| Top (Draw Function = 3, 4, 5, 7, 8) | 3 | 000 to FFF | |
| Right (Draw Function = 3, 4, 5, 7, 8) | 3 | 000 to FFF | |
| Bottom (Draw Function = 3, 4, 5, 7, 8) | 3 | 000 to FFF | |
| Oval Width (Draw Function = 5) | 3 | 000 to FFF | |
| Oval Height (Draw Function = 5) | 3 | 000 to FFF | |
| Start Angle (Draw Function = 6, 8) | 3 | 000 to FFF | |
| Arc Size (Draw Function = 6, 8) | 3 | 000 to FFF | |
| Radius (Draw Function = 6) | 3 | 000 to FFF | |
| Horz Pixel Center (Draw Function = 6) | 3 | 000 to FFF | |
| Vert Pixel Center (Draw Function = 6) | 3 | 000 to FFF | |
| ~~ | Checksum | 00 to FFF | |

Draw Function=0 draws a point

Draw Function=1 draws a line

Draw Function=2 draws multiple lines

Draw Function=3 draws a rectangle

Draw Function=4 draws a grayed out rectangle

Draw Function=5 draws a rounded rectangle

Draw Function=6 draws a circle

Draw Function=7 draws an oval

Draw Function=8 draws an arc

Color is the drawing object color using the RGB color scheme (this could be other color schemes as well)

Width is the drawing object width

Style=0 is solid

Style=1 is dash

Style=2 is dot

Style=3 is dash-dot

Style=4 is dash-dot-dot

End X (Draw Function=0, 1) is the x-coordinate where the point or line ends

End Y (Draw Function=0, 1) is the y-coordinate where the point or line ends

Absolute Coordinates (Draw Function=1)=0 is the line new position is in relative coordinates

Absolute Coordinates (Draw Function=1)=1 is the line new position is in absolute coordinates

End Xn (Draw Function=2) is the x-coordinate of the line to draw

˜ Separator for x and y coordinate during a multiple line draw operation

End Yn (Draw Function=2) is the y-coordinate of the line to draw

Fill (Draw Function=2, 3, 5, 6, 7, 8)=0 is not to fill the object with selected color

Fill (Draw Function=2, 3, 5, 6, 7, 8)=1 is to fill the object with selected color

Left (Draw Function=3, 4, 5, 7, 8) is the horizontal coordinate of the left edge

Top (Draw Function=3, 4, 5, 7, 8) is the vertical coordinate of the top edge

Right (Draw Function=3, 4, 5, 7, 8) is the horizontal coordinate of the right edge

Bottom (Draw Function=3, 4, 5, 7, 8) is the vertical coordinate of the bottom edge

Oval Width (Draw Function=5) is the width of an oval that defines the amount of curvature for the corners

Oval Height (Draw Function=5) is the height of an oval that defines the amount of curvature for the corners

Start Angle (Draw Function=6, 8) determines where the arc or circle begins (in degrees)

Arc Size (Draw Function=6, 8) determines the degree value for the arc or circle to draw

Radius (Draw Function=6) determines the size of the circle (in pixels)

Horz Pixel Center (Draw Function=6) is the pixel center of the circle relative to the x-coordinate of the current origin

Vert Pixel Center (Draw Function=6) is the pixel center of the circle relative to the y-coordinate of the current origin

For example, if the screen received an object such as that illustrated in the screenshot 500 of FIG. 5.

The parameters would be:

Draw Function=6

Color=FFF312

Width=001

Style=0

Fill=1

Start Angle=000

Arc Size=168

Radius=020

Therefore, the actual message encoded on the server would be:

B1_{—}108/29/2006 15:35-D12

6FFF31200101000168020˜˜17

where 17 is the checksum value of the line

6FFF3′1200101000168020˜˜

B1_{—}1 means this is background graphic message 1 of 1. (If Orange County needed 3 background graphic messages this could be B1_{—}3 meaning background message 1 of 3).

08/29/2006 15:35 is the timestamp for the background message information.

- is a separator between Timestamp and Region

D12 is the District/Area of traffic information. In this case it is D12 which is the Orange County Region. D3 is the Sacramento Region. D4 is the San Francisco Region. D7 is the Los Angeles Region. D8 is the San Bernardino Region. D11 is the San Diego Region, etc.

Within the encoded message, the header B-1_{—}1 08/29/2006 15:35-D12 can be compressed using the following conversion codes:

| | |
|---|---|
| T1_{—} | { |
| I1_{—} | } |
| A1_{—} | , |
| B1_{—} | ! |
| E1_{—} | \grave{ } |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| 26/20 | ′ |
| 27/20 | S |
| 28/20 | R |
| 29/20 | Q |
| 30/20 | P |
| 31/20 | O |
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| -D3 | & |
| -D4 | % |
| -D7 | $ |
| -D8 | # |
| -D11 | ″ |
| -D12 | \| |

So the header becomes:

!1sQ06C35|

The encoded message body

6FFF31200101000168020˜˜17

can be compressed using the following conversion codes:

| | |
|---|---|
| 00 | ! |
| 01 | ″ |
| 02 | # |
| 03 | $ |
| 04 | % |
| 05 | & |
| 06 | ′ |
| 07 | ( |
| 08 | ) |
| 09 | * |
| 0A | + |
| 0B | , |
| 0C | - |
| 0D | . |
| 0E | / |
| 0F | : |
| 10 | ; |
| 11 | < |
| 12 | > |
| 13 | ? |
| 14 | @ |
| 15 | G |
| 16 | H |
| 17 | I |
| 18 | J |
| 19 | K |
| 1A | L |
| 1B | M |
| 1C | N |
| 1D | O |
| 1E | P |
| 1F | Q |
| 20 | R |
| 21 | S |
| 22 | T |
| 23 | U |
| 24 | V |
| 25 | W |
| 26 | X |
| 27 | Y |
| 28 | Z |
| 29 | [ |
| 2A | \ |
| 2B | ] |
| 2C | \hat{ } |
| 2D | _{—} |
| 2E | a |
| 2F | b |
| 30 | c |
| 31 | d |
| 32 | e |
| 33 | f |
| 34 | g |
| 35 | h |
| 36 | i |
| 37 | j |
| 38 | k |
| 39 | l |
| 3A | m |
| 3B | n |
| 3C | o |
| 3D | p |
| 3E | q |
| 3F | r |
| FF | s |
| FE | t |
| FD | u |
| ~~ | v |
| FC | w |
| FB | x |
| FA | y |
| 40 | z |
| 80 | \| |
| 60 | } |
| 50 | { |
| 70 | \grave{ } |

Thus, the compressed message body becomes:

6sF3>!1″!″68#0vI

Therefore, the complete compressed message sent from the server to users would be:

!1sQ06C35|

6sF3>!1″!″68#0vI

When the user(s) receives the packet(s), the software decompresses the header !1sQ06C35| using the following conversion codes:

| | |
|---|---|
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| 26/20 | ' |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| T1_{—} | { |
| 27/20 | S |
| 28/20 | R |
| 29/20 | Q |
| 30/20 | P |
| 31/20 | O |
| I1_{—} | } |
| A1_{—} | , |
| B1_{—} | ! |
| E1_{—} | \grave{ } |
| -D3 | & |
| -D4 | % |
| -D7 | $ |
| -D8 | # |
| -D11 | ″ |
| -D12 | \| |

Thus, the header !1sQ06C35| becomes

B1_{—}1 08/29/2006 15:35-D12

To decompress the message body 6sF3>!1″!″68#0vI use the following conversion codes:

| | |
|---|---|
| 00 | ! |
| 01 | ″ |
| 02 | # |
| 03 | $ |
| 04 | % |
| 05 | & |
| 06 | ' |
| 07 | ( |
| 08 | ) |
| 09 | * |
| 0A | + |
| 0B | , |
| 0C | - |
| 0D | . |
| 0E | / |
| 0F | : |
| 10 | ; |
| 11 | < |
| 12 | > |
| 13 | ? |
| 14 | @ |
| 15 | G |
| 16 | H |
| 17 | I |
| 18 | J |
| 19 | K |
| 1A | L |
| 1B | M |
| 1C | N |
| 1D | O |
| 1E | P |
| 1F | Q |
| 20 | R |
| 21 | S |
| 22 | T |
| 23 | U |
| 24 | V |
| 25 | W |
| 26 | X |
| 27 | Y |
| 28 | Z |
| 29 | [ |
| 2A | \ |
| 2B | ] |
| 2C | \hat{ } |
| 2D | _{—} |
| 2E | a |
| 2F | b |
| 30 | c |
| 31 | d |
| 32 | e |
| 33 | f |
| 34 | g |
| 35 | h |
| 36 | i |
| 37 | j |
| 38 | k |
| 39 | l |
| 3A | m |
| 3B | n |
| 3C | o |
| 3D | p |
| 3E | q |
| 3F | r |
| FF | s |
| FE | t |
| FD | u |
| ~~ | v |
| FC | w |
| FB | x |
| FA | y |
| 40 | z |
| 80 | \| |
| 60 | } |
| 50 | { |
| 70 | \grave{ } |

Thus, the message body is decompressed as:

6FFF31200101000168020˜˜17

The graphic protocol is listed below in TABLE 4.

| Parameter Name | Bytes | Range (Hex) | Comment |
|---|---|---|---|
| Color | 6 | 000000 to | |
| | | FFFFFF | |
| Width | 3 | 000 to FFF | |
| Style | 1 | 0 to 4 | |
| ~H | 2 | | Row Separator |
| Rows | 3 | 000 to FFF | |
| ~K | 2 | | Column Separator |
| Columns | 3 | 000 to FFF | |
| ~G | 2 | | Start of XY Coordinates |
| \grave{ } | 1 | | Skip Byte X 8 |
| Data | 2 | 00 to FF | |
| ~O | 1 | | Offset |
| | | 00 to FFF each | |
| | \grave{ }xxx\grave{ }yyy | byte | Offset Byte Pointer |
| | | | Position X 8 |
| ~~ | Checksum | 00 to FFF | |

Color is the drawing color using the RGB color scheme (this could be other color schemes as well)

Width is the drawing object width

Style=0 is solid

Style=1 is dash

Style=2 is dot

Style=3 is dash-dot

Style=4 is dash-dot-dot

˜H is a separator before specifying the number of rows

Rows is the number of rows

˜K is a separator before specifying the number of columns

Columns is the number of columns

˜G denotes the start of graphic data

′ denotes skip the number of pixels times 8

Data is the graphic data to be displayed

˜O denotes the offset or where graphic data starts in subsequent message(s) if it takes at least 2 messages to construct the graphic. This value is in the number of pixel times 8.

˜˜ is the checksum separator

For example, if the screen received an object like that in screenshot 600 of FIG. 6.

Color=FFFFFF

Width=1

Style=0

˜H60

˜K60

˜G′C2FFFFFF′04FFFFFF′02FFFFFF′04FFFFFF′02FFFFFF′04FFFFFF′02FFF FFF′04FFFFFF′02FFFFFF′04FFFFFF′02FFFFFF′04FFFFFF′02FFFFFF′04FFFFFF′02 FFFFFF′04FFFFFF′02FFFFFF′04FFFFFF′02FFFFFF′04FFFFFF′02FFFFFF′04FFFFF F′02FFFFFF′04FFFFFF′02FFFFFF′04FFFFFF′02FFFFFF′04FFFFFF′02FFFFFF′04FF FFFF′02FFFFFF′04FFFFFF′10FFFFFFFF′08FFFFFFFF′08FFFFFFFF′08FFFFFFFF′0 8FFFFFFFF′08FFFFFFFF′08FFFFFFFF′08FFFFFFFF′08FFFFFFFF′08FFFFFFFF′08F FFFFFFF′08FFFFFFFF′08FFFFFFFF′08FFFFFFFF′08FFFFFFFF′05 FF′08FF′02FF′08 FF′02FF′08FF′02FF′08FF′02FF′08FF′02FF′08FF′02FF′08FF′02FF′08FF′03FF′06FF′04FF′06FF′04FF′06FF′04FF′06FF′04FF′06FF′04FF′06FF′04FF′06FF′04FF′06FF′05F F′04FF′06FF′04FF′06FF′04FF′06FF′04FF′06FF′04FF′06FF′04FF′06FF′04FF′06FF′0 4FF′07FFFFFFFF′08FFFFFFFF′08FFFFFFFF′08FFFFFFFF′08FFFFFFFF′08FFFFFFF F′08FFFFFFFF′08FFFFFFFF′09FFFF′0AFFFF′0AFFFF′0AFFFF′0AFFFF′0AFFFF′0AFFFF′0AFFFF′0A

The encoded message(s) on the server would be:

A1_{—}3 08/29/2006 15:35-D12

FFFFFF10˜H60˜K60˜G′C2FFFFFF′04FFFFFF′02FFFFFF′04FFFFFF′02F FFFFF′04FFFFFF′02FFFFFFFF′04FFFFFF′02FFFFFF′04FFFFFF′02FFFFFF′04FF FFFF′02FFFFFF′04FFFFFF′02FFFFFF′04FFFFFF′02FFFFFF′04FFFFFF′02FFF FFF′04FFFFFF′02FFFFFF′04FFFFFF′02FFFFFF′04FFFFFF′02FFFFFF′04FFFF FF′02FFFFFF′04FFFFFF′02FFFFFF′04FFFFFF˜O0′173′0′0′0′0′˜˜132

A2_{—}3 08/29/2006 15:35-D12

′02FFFFFF′04FFFFFF′10FFFFFFFF′08FFFFFFFF′08FFFFFFFF′08FFFF FFFF′08FFFFFFFF′08FFFFFFFF′08FFFFFFFF′08FFFFFFFF′08FFFFFFFF′08F FFFFFFF′08FFFFFFFF′08FFFFFFFF′08FFFFFFFF′08FFFFFFFF′08FFFFFFFF′05FF′08FF′02FF′08FF′02FF′08FF′02FF′08FF′02FF′08FF′02FF′08FF′02FF′08FF′02FF′08FF′03FF′06FF′04FF′06FF′04FF′06FF′04FF′06FF′04FF˜O173′2D2′0′0′0′0 ′˜˜148

A3_{—}3 08/29/2006 15:35-D12

′06FF′04FF′06FF′04FF′06FF′04FF′06FF′05FF′04FF′06FF′04FF′06FF′04F F′06FF′04FF′06FF′04FF′06FF′04FF′06FF′04FF′06FF′04FF′07FFFFFFFF′08FFF FFFFF′08FFFFFFFF′08FFFFFFFF′08FFFFFFFF′08FFFFFFFF′08FFFFFFFF′08 FFFFFFFF′09FFFF′0AFFFF′0AFFFF′0AFFFF′0AFFFF′0AFFFF′0AFFFF′0AFF FF˜O2D2′41A′0′0′0′0′˜˜117

If only a portion of these messages is analyzed, the logic can subsequently be inferred.

A1_{—}3 08/29/2006 15:35-D12 is the header meaning graphic message 1 of 3.

FFFFFF is the color

1 denotes width of graphic will be 1 pixel

0 denotes style will be solid

˜H60 denotes 96 rows (60 hex=96 decimal)

˜K60 denotes 96 columns (60 hex=96 decimal)

˜G means start updating pixel locations with the color previously specified.

′C2 is a 2-digit (8 bit) hexadecimal number meaning to skip C2 hex (or 194 decimal)×8 indices within the graphic grid of 96 row and 96 columns previously specified. Thus, for a 96 by 96 grid, ′C2 denotes skip to pixel index 1552 (C2 hex (or 194 decimal)×8=1552). Note the accent character in front of the hex number.

FF means fill pixel index 1553 through 1560 with the specified color

FF means fill pixel index 1561 through 1568 with the specified color

FF means fill pixel index 1569 through 1576 with the specified color

′04 is a 2-digit (8 bit) hexadecimal number meaning to skip 04 hex (or 4 decimal)×8 indices within the graphic grid of 96 row and 96 columns previously specified. The last pixel index left off was 1576. Hence ′04 denotes to skip (04 hex (4 decimal)×8=32) indices from pixel index 1576.

This logic continues until a −0 is reached.

˜O is the offset pixel index pointer used to ensure the graphic plotting scheme is correct for multiple graphic messages. The information that follows is 2-digits (8-bit) hexadecimal numbers which give last offset pointers for each pixel index. This is used to track where the pixel pointer was last pointed to if there was more than one message.

0′ 173 means this particular message started counting at pixel index 0. The ending pixel index is at 173 hex (or 371 decimal)×8=2968 pixel index. Thus the next message would start counting from pixel index 2968

0′0′0′0′ is reserved for future use.

˜˜132 is the checksum for that message in hex

Analyzing the second message

A2_{—}3 08/29/2006 15:35-D12 is the header meaning graphic message 2 of 3.

′02 is a 2-digit (8 bit) hexadecimal number meaning to skip 02 hex (or 2 decimal)×8=16 indices while pointing at 173 hex (or 371 decimal)×8=2968 pixel index.

So now the pointer is pointing to pixel index 16+2968=2984

FF means fill pixel index 2984 through 2991 with the specified color

FF means fill pixel index 2992 through 2999 with the specified color

FF means fill pixel index 3000 through 3007 with the specified color

′04 is a 2-digit (8 bit) hexadecimal number meaning to skip 04 hex (or 4 decimal)×8 indices within the graphic grid of 96 row and 96 columns previously specified. The last pixel index pointed to was 3007. Hence ′04 denotes to skip 04 hex (or 4 decimal)×8=32) indices from pixel index 3007.

This logic continues until a ˜O is reached.

˜O is the offset pixel index pointer used to ensure the graphic plotting scheme is correct for multiple graphic messages. The information that follows is 2-digits (8-bit) hexadecimal numbers which give last offset pointers for each pixel index. This is used to track where the pixel pointer was last pointed to if there was more than one message.

173′2D2 means this particular message started counting at pixel index 173hex (or 371 decimal)×8=2968. The ending pixel index is at 2D2 hex (or 722 decimal)×8=5776 pixel index. Thus the next message would start counting from pixel index 5776

′0′0′0′0′0′ is reserved for future use.

˜˜148 is the checksum for that message in hex

Analyzing the third message

A3_{—}3 08/29/2006 15:35-D12 is the header meaning graphic message 3 of 3.

′06 is a 2-digit (8 bit) hexadecimal number meaning to skip 06×8=48 indices while pointing at 2D2 hex (or 722 decimal)×8=5776 pixel index.

So now the pointer is pointing to pixel index 48+5776=5824

FF means fill pixel index 2984 through 2991 with the specified color

FF means fill pixel index 2992 through 2999 with the specified color

FF means fill pixel index 3000 through 3007 with the specified color

′06 is a 2-digit (8 bit) hexadecimal number meaning to skip 06 hex (or 6 decimal)×8 indices within the graphic grid of 96 row and 96 columns specified in message 1. The last pixel index pointed to was 3007. Hence ′06 denotes to skip (06 hex (or 6 decimal)×8=48) indices from pixel index 3007.

This logic continues until a −0 is reached.

˜O is offset pixel index pointer used to ensure the graphic plotting scheme is correct for multiple graphic messages. The information that follows is 2-digits (8-bit) hexadecimal numbers which give last offset pointers for each pixel index. This is used to track where the pixel pointer was last pointed to if there was more than one message.

2D2′41A means this particular message started counting at pixel index 2D2 hex (or 722 decimal)×8=5776. The ending pixel index is at 41A hex (or 1050 decimal)×8=8400 pixel index.

′0′0′0′0′ is reserved for future use.

˜˜117 is the checksum for that message in hex

The headers can be compressed using the following conversion codes:

| | |
|---|---|
| T1_{—} | { |
| I1_{—} | } |
| A1_{—} | , |
| B1_{—} | ! |
| E1_{—} | \grave{ } |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| 26/20 | ' |
| 27/20 | S |
| 28/20 | R |
| 29/20 | Q |
| 30/20 | P |
| 31/20 | O |
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| -D3 | & |
| -D4 | % |
| -D7 | $ |
| -D8 | # |
| -D11 | ″ |
| -D12 | \| |

Thus, the headers become:

,3sQ06C35|

A2_{—}3sQ06C35|

A3_{—}3sQ06C35|

The encoded graphic message body can be compressed using the following conversion codes:

| | |
|---|---|
| 0\grave{ }0\grave{ }0\grave{ }0\grave{ } | { |
| 0\grave{ }0\grave{ }0\grave{ } | } |
| ~O0\grave{ } | \| |
| 0\grave{ }0\grave{ } | z |
| \grave{ }01 | y |
| \grave{ }02 | x |
| \grave{ }03 | w |
| \grave{ }04 | v |
| \grave{ }05 | u |
| \grave{ }06 | t |
| \grave{ }07 | s |
| \grave{ }08 | r |
| \grave{ }09 | q |
| \grave{ }0A | p |
| \grave{ }0B | o |
| \grave{ }0C | n |
| \grave{ }0D | m |
| \grave{ }0E | l |
| \grave{ }0F | k |
| \grave{ }10 | j |
| \grave{ }20 | i |
| \grave{ }40 | h |
| \grave{ }80 | g |
| ~~0 | f |
| ~~1 | e |
| ~~2 | d |
| ~~3 | c |
| ~~4 | b |
| ~~5 | a |
| ~~6 | _{—} |
| ~~7 | \hat{ } |
| ~~8 | ] |
| ~~9 | \ |
| ~~A | [ |
| ~~B | Z |
| ~~C | Y |
| ~~D | X |
| ~~E | W |
| ~~F | V |
| 01 | U |
| 02 | T |
| 03 | S |
| 04 | R |
| 05 | Q |
| 06 | P |
| 07 | O |
| 08 | N |
| 09 | M |
| 0A | L |
| 0B | K |
| 0C | J |
| 0D | I |
| 0E | H |
| 0F | G |
| 10 | @ |
| 20 | ? |
| 40 | > |
| 80 | < |
| 0\grave{ } | ; |
| FF | : |
| FE | / |
| FD | . |
| FC | - |
| FB | , |
| FA | + |
| 70 | * |
| 60 | ) |
| 50 | ( |
| 30 | ' |
| 1B | & |
| 1C | % |
| ~K | $ |
| ~G | # |
| ~H | ″ |
| ~O | ! |

Thus, the message bodies become:

:::@″)$)#′C2:::v:::x:::v:::x:::v:::x:::v:::x:::v:::x:::v:::x:::v:::x:::v:::x:::v:::x :::v:::x:::v:::x:::v:::x:::v:::x:::v:::x:::v:::x:::v:::|173′{e32

x:::v:::j:::: r::::r::::r::::r::::r::::r::::r::::r::::r::::r::::r::::r::::r::::r::::u:r:x:r: x:r:x:r:x:r:x:r:x:r:x:r:w:t:v:t:v:t:v:!173′2D2′{e48

t:v:t:v:t:v:t:u:v:t:v:t:v:t:v:t:v:t:v:t:v:t:v:s::::r::::r::::r::::r::::r::::r::::r::::q::

p::p::p::p::p::p::p::!2D2′41A′{e17

Therefore, combining the headers and message bodies, the three messages become:

,3sQ06C35|

:::@″)$)#′C2:::v:::x:::v:::x:::v:::x:::v:::x:::v:::x:::v:::x:::v:::x:::v:::x:::v:::x :::v:::X:::v:::x:::v:::x:::v:::x:::v:::x:::v:::|173′{e32

A2_{—}3sQ06C35|

x:::v:::j::::r::::r::::r::::r::::r::::r::::r::::r::::r::::r::::r::::r::::r::::r::::u:r:x:r: x:r:x:r:x:r:x:r:x:r:x:r:w:t:v:t:v:t:v:t:v:!173′2D2′{e48

A3_{—}3sQ06C35|

t:v:t:v:t:v:t:u:v:t:v:t:v:t:v:t:v:t:v:t:v:t:v:s::::r::::r::::r::::r::::r::::r::::r::::q:: p::p::p::p::p::p::p::!2D2′41A′{e17

To decompress the headers, the following conversion codes can be

| | |
|---|---|
| 00: | : |
| 01: | N |
| 02: | M |
| 03: | L |
| 04: | K |
| 05: | J |
| 06: | ( |
| 07: | H |
| 08: | G |
| 09: | @ |
| 10: | ? |
| 11: | > |
| 12: | < |
| 13: | E |
| 14: | B |
| 15: | C |
| 16: | D |
| 17: | * |
| 18: | F |
| 19: | ; |
| 20: | ) |
| 21: | / |
| 22: | . |
| 23: | - |
| 26/20 | ' |
| 01/ | z |
| 02/ | y |
| 03/ | x |
| 04/ | w |
| 05/ | v |
| 06/ | u |
| 07/ | t |
| 08/ | s |
| 09/ | r |
| 10/ | q |
| 11/ | p |
| 12/ | o |
| 01/20 | n |
| 02/20 | m |
| 03/20 | l |
| 04/20 | k |
| 05/20 | j |
| 06/20 | i |
| 07/20 | h |
| 08/20 | g |
| 09/20 | f |
| 10/20 | e |
| 11/20 | d |
| 12/20 | c |
| 13/20 | b |
| 14/20 | a |
| 15/20 | + |
| 16/20 | \hat{ } |
| 17/20 | ] |
| 18/20 | \ |
| 19/20 | [ |
| 20/20 | Z |
| 21/20 | Y |
| 22/20 | X |
| 23/20 | W |
| 24/20 | V |
| 25/20 | U |
| T1_{—} | { |
| 27/20 | S |
| 28/20 | R |
| 29/20 | Q |
| 30/20 | P |
| 31/20 | O |
| I1_{—} | } |
| A1_{—} | , |
| B1_{—} | ! |
| E1_{—} | \grave{ } |
| -D3 | & |
| -D4 | % |
| -D7 | $ |
| -D8 | # |
| -D11 | ″ |
| -D12 | \| |

The headers become:

A1_{—}3 08/29/2006 15:35-D12

A2_{—}3 08/29/2006 15:35-D12

A3_{—}3 08/29/2006 15:35-D12

To decompress the message bodies, the following conversion codes can be used:

| | |
|---|---|
| 0F | G |
| 0E | H |
| 0B | K |
| 07 | O |
| ~G | # |
| ~H | ″ |
| ~K | $ |
| ~O | ! |
| \grave{ }01 | y |
| \grave{ }02 | x |
| \grave{ }03 | w |
| \grave{ }04 | v |
| \grave{ }05 | u |
| \grave{ }06 | t |
| \grave{ }07 | s |
| \grave{ }08 | r |
| \grave{ }09 | q |
| \grave{ }0A | p |
| \grave{ }0B | o |
| \grave{ }0C | n |
| \grave{ }0D | m |
| \grave{ }0E | l |
| \grave{ }0F | k |
| \grave{ }10 | j |
| \grave{ }20 | i |
| \grave{ }40 | h |
| \grave{ }80 | g |
| 0\grave{ }0\grave{ }0\grave{ }0\grave{ } | { |
| 0\grave{ }0\grave{ }0\grave{ } | } |
| ~O0\grave{ } | \| |
| 0\grave{ }0\grave{ } | z |
| ~~0 | f |
| ~~1 | e |
| ~~2 | d |
| ~~3 | c |
| ~~4 | b |
| ~~5 | a |
| ~~6 | _{—} |
| ~~7 | \hat{ } |
| ~~8 | ] |
| ~~9 | \ |
| ~~A | [ |
| ~~B | Z |
| ~~C | Y |
| ~~D | X |
| ~~E | W |
| ~~F | V |
| 01 | U |
| 02 | T |
| 03 | S |
| 04 | R |
| 05 | Q |
| 06 | P |
| 08 | N |
| 09 | M |
| 0A | L |
| 0C | J |
| 0D | I |
| 10 | @ |
| 20 | ? |
| 40 | > |
| 80 | < |
| 0\grave{ } | ; |
| FF | : |
| FE | / |
| FD | . |
| FC | - |
| FB | , |
| FA | + |
| 70 | * |
| 60 | ) |
| 50 | ( |
| 30 | ' |
| 1B | & |
| 1C | % |

Thus, the graphic message bodies become:

FFFFFF10—H60—K60—G′C2FFFFFF′04FFFFFF′02FFFFFF′04FFFFFF′02F FFFFF′04FFFFFF′02FFFFFF′04FFFFFF′02FFFFFF′04FFFFFF′02FFFFFF′04FF FFFF′02FFFFFF′04FFFFFF′02 FFFFFF′04FFFFFF′02FFFFFF′04FFFFFF′02FFF FFF′04FFFFFF′02FFFFFF′04FFFFFF′02FFFFFF′04FFFFFF′02FFFFFF′04FFFF FF′02FFFFFF′04FFFFFF′02FFFFFF′04FFFFFF˜O0′173′0′0′0′0′˜˜132

′02FFFFFF′04FFFFFF′10FFFFFFFF′08FFFFFFFF′08FFFFFFFF′08FFFF FFFF′08FFFFFFFF′08FFFFFFFF′08FFFFFFFF′08FFFFFFFF′08FFFFFFFF′08F FFFFFFF′08FFFFFFFF′08FFFFFFFF′08FFFFFFFF′08FFFFFFFF′08FFFFFFFF′05FF′08FF′02FF′08FF′02FF′08FF′02FF′08FF′02FF′08FF′02FF′08FF′02FF′08FF′02FF′08FF′03FF′06FF′04FF′06FF′04FF′06FF′04FF′06FF′04FF˜O173′2D2′0′0′0′0 ′˜˜148

′06FF′04FF′06FF′04FF′06FF′04FF′06FF′05FF′04FF′06FF′04FF′06FF′04F F′06FF′04FF′06FF′04FF′06FF′04FF′06FF′04FF′06FF′04FF′07FFFFFFFF′08FFF FFFFF′08FFFFFFFF′08FFFFFFFF′08FFFFFFFF′08FFFFFFFF′08FFFFFFFF′08 FFFFFFFF′09FFFF′0AFFFF′0AFFFF′0AFFFF′0AFFFF′0AFFFF′0AFFFF′0AFF FF˜O2D2′41A′0′0′0′0′˜˜117

Therefore, combining the decompressed header and graphic bodies yields:

A1_{—}3 08/29/2006 15:35-D12

FFFFFF10˜H60˜K60˜G′C2FFFFFF′04FFFFFF′02FFFFFF′04FFFFFF′02F FFFFF′04FFFFFF′02FFFFFF′04FFFFFF′02FFFFFF′04FFFFFF′02FFFFFF′04FF FFFF′02FFFFFF′04FFFFFF′02FFFFFF′04FFFFFF′02FFFFFF′04FFFFFF′02FFF FFF′04FFFFFF′02FFFFFF′04FFFFFF′02FFFFFF′04FFFFFF′02FFFFFF′04FFFF FF′02FFFFFF′04FFFFFF′02FFFFFF′04FFFFFF˜O0′173′0′0′0′0′˜˜132

A2_{—}3 08/29/2006 15:35-D12

′02FFFFFF′04FFFFFF′10FFFFFFFF′08FFFFFFFF′08FFFFFFFF′08FFFF FFFF′08FFFFFFFF′08FFFFFFFF′08FFFFFFFF′08FFFFFFFF′08FFFFFFFF′08F FFFFFFF′08FFFFFFFF′08FFFFFFFF′08FFFFFFFF′08FFFFFFFF′08FFFFFFFF′05FF′08FF′02FF′08FF′02FF′08FF′02FF′08FF′02FF′08FF′02FF′08FF′02FF′08FF′02FF′08FF′03FF′06 FF′04FF′06 FF′04 FF′06FF′04 FF′06 FF′04 FF˜O173′2D2′0′0′0′0 ′˜˜148

A3_{—}3 08/29/2006 15:35-D12

′06FF′04FF′06FF′04FF′06FF′04FF′06FF′05FF′04FF′06FF′04FF′06FF′04F F′06FF′04FF′06FF′04FF′06FF′04FF′06FF′04FF′06FF′′04FF′07FFFFFFFF′08FFF FFFFF′08FFFFFFFFF′08FFFFFFFF′08FFFFFFFF′08FFFFFFFF′08FFFFFFFF′08FFFFFFFF′09FFFF′0AFFFF′0AFFFF′0AFFFF′0AFFFF′0AFFFF′0AFFFF′0AFF FF˜O2D2′41A′0′0′0′0′˜˜117

An over the air programming protocol can be used to update information residing within the client software without having the user manually download or bring their unit into a service provider for updating. For example, if the customer gets a new carrier, the server can update carrier information and SMS gateway access number over the air. Other parameters can be updated on the user platform over the air as well.

| Parameter Name | Bytes | Range (Hex) | Comment |
|---|---|---|---|
| \grave{ } | 1 | | Skip Byte |
| Data | 2 | 00 to FF | |
| ~~ | Checksum | 00 to FFF | |

\grave{ } denotes skip the number of bytes
Data is data to send
~~ is the checksum separator

For example to change the second parameter with the value 09 within the parameters file the server would encode the following:

P1_{—}1 08/29/2006 15:35-D12

′0209˜˜07

P1_{—}1 08/29/2006 15:35-D12 is the header meaning program message 1 of 1

P1_{—}1 means this is text message 1 of 1. (If Orange County needed 3 text messages this could be P1_{—}3 meaning text message 1 of 3).

08/29/2006 15:35 is the timestamp for the text information.

- is a separator between Timestamp and Region

D12 is the District/Area of traffic information. In this case it is D12 which is the Orange County Region. D3 is the Sacramento Region. D4 is the San Francisco Region. D7 is the Los Angeles Region. D8 is the San Bernardino Region. D11 is the San Diego Region, etc.

′02 denotes to point to the second byte

09 denotes to change the value 09 (hex)

07 is the checksum value from ′0209˜˜

Note: The header and message body need not be compressed at this time. However, in some implementations, the header and message body can be compressed and later decompressed.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input requesting device, and at least one output requesting device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or requesting device (e.g., magnetic discs, optical disks, memory, Programmable Logic Initiating devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display requesting device (e.g., a CRT (cathode ray tube) or LCD (liquid crystal display) monitor) for displaying information to the user and a keyboard and a pointing requesting device (e.g., a mouse or a trackball) by which the user may provide input to the computer. Other kinds of requesting devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing, system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

What is claimed is:

1. An article comprising a tangibly-embodied machine-readable medium operable to cause one or more machines to result in operations comprising:
receiving an SMS message from a requesting device requesting a traffic update and characterizing a region of interest and identifying a communications service provider associated with the requesting device, the requesting device displaying a digital image of the region of interest;
collecting traffic information for the traffic region of interest; and
sending a plurality of SMS messages containing the traffic information to the requesting device via an SMS gateway associated with the communications service provider to enable a plurality of traffic designation points overlaid on the digital image of the region of interest to be displayed with the traffic information.

2. An article as in claim 1, wherein the requesting device is a mobile communications handset.

3. An article as in claim 1, wherein the requesting device is a vehicle mounted computer.

4. An article as in claim 1, wherein the requesting device is a mobile computer.

5. An article as in claim 1, wherein the SMS gateway is a gateway operated by the communications provider.

6. An article as in claim 2, wherein the SMS message further includes an identification code identifying the mobile communications handset; and
wherein the article is further operable to invoice an account associated with the identification code based on a number of sent SMS messages containing the traffic information.

7. An article as in claim 1, wherein the collecting comprises: polling a traffic server, by a messaging server, to obtain data characterizing traffic.

8. An article as in claim 7, wherein the traffic server:
receives traffic data from a plurality of remote data sources;
encodes the traffic data;
packetizes the encoded traffic data;
compresses the packetized encoded traffic data; and
transmits one or more SMS messages containing the compresses packetized encoded traffic data to the messaging server.

9. An article as in claim 8, wherein the remote data sources are selected from a group comprising: roadway traffic speed sensors, roadway cameras, remote servers, and wirelessly transmitting data sources.

10. An article as in claim 1, wherein the SMS message requesting the traffic update further characterizes a version number of software installed on the requesting device.

11. An article as in claim 10, wherein the plurality of sent SMS messages are generated to be compatible with the version number of the software installed on the requesting device.

12. An article as in claim 1, wherein the requesting device:
receives the plurality of sent SMS messages;
decompresses the plurality of SMS messages received by the requesting device;
decodes the decompressed plurality of SMS messages; and
parses the decoded decompressed plurality of SMS messages.

13. An article as in claim 1, wherein the requesting device:
receives the plurality of sent SMS messages; and
modifies a visual representation of one or more of the plurality of traffic designation points overlaid on the digital image of the region of interest based on the content of the plurality of received SMS messages.

14. An article as in claim 10, wherein subsets of the plurality of traffic designation points are updated as individual sent SMS messages are received by the requesting device.

15. An article as in claim 1, wherein the article is further operable to cause one or more machines to result in operations comprising:
sending an incident notification SMS message to the requesting device via the SMS gateway associated with the communications service provider, the incident notification SMS message characterizing a description and location of an incident, to enable an incident designation point to be overlaid on the digital image of the region of interest at a point on the digital image corresponding to the location of the incident.

16. An article as in claim 15, wherein the description of the incident characterizes a type of incident and a time of the incident.

17. An article as in claim 1, wherein the article is further operable to cause one or more machines to result in operations comprising:
receiving a second SMS message from the requesting device requesting a second traffic update and characterizing a second user-selected region of interest, the requesting device displaying a digital image of the second user-selected region of interest;
collecting traffic information for the second user-selected region of interest; and
sending a second plurality of SMS messages containing the traffic information to the requesting device via the SMS gateway to enable a plurality of second traffic designation points overlaid on the digital image of the second user-selected region of interest to be displayed with the traffic information.

18. An article as in claim 1, wherein the article is further operable to cause one or more machines to result in operations comprising:
sending one or more advertisements associated with the traffic region of interest in one or more SMS messages to the requesting device via the SMS gateway for display on the requesting device.

19. An article as in claim 1, wherein the SMS message received from the requesting device identifies whether at least one advertisement is to be bundled with the traffic informationt.

20. An article as in claim 1, wherein the SMS message received from the requesting device is generated in response to a user activating an application on the requesting device.

21. An article as in claim 1, wherein the article is further operable to cause one or more machines to result in operations comprising:
receiving a SMS message from the requesting device indicating that one or more of the plurality of SMS messages containing the traffic information was not received by the requesting device; and
sending additional SMS messages containing the traffic information omitted from the previously sent plurality of SMS messages.

22. An article as in claim 21, further comprising send a message to a billing server indicating that an account associated with the requesting device should not be invoiced for the sent additional SMS messages.

23. An article as in claim 21, wherein the plurality of sent SMS messages further contain advertisements for visual display in connection with the traffic information.

24. A system comprising:
a traffic server coupled to a plurality of data sources, the data sources providing traffic information characterizing vehicle speeds in a region of interest and incident information characterizing a traffic incident and a location of the traffic incident, the traffic server generating a plurality of SMS messages containing compressed packetized traffic information and incident information; and
a messaging server coupled to the traffic server for receiving the SMS messages generated by the traffic server, the messaging server coupled to a communications network to receive SMS messages from requesting devices that each request a traffic update, characterize a region of interest and identify a communications service provider associated with the corresponding requesting device, each requesting device displaying a digital image of the region of interest, the messaging server sending a plurality of SMS messages containing the traffic information to each requesting device via an SMS gateway associated with the corresponding communications service provider to enable a plurality of traffic designation points overlaid on the digital image of the region of interest to be displayed with the traffic information.

25. An article comprising a tangibly-embodied machine-readable medium operable to cause one or more machines to result in operations comprising:
receiving a plurality of SMS messages from a requesting device each requesting a traffic update and characterizing one region of interest within a traffic zone comprising a plurality of regions of interest and identifying a communications service provider associated with the requesting device, the requesting device displaying a digital image of the traffic zone;
collecting traffic information for each traffic region of interest within the traffic zone; and
sending a plurality of SMS messages containing the traffic information to the requesting device via an SMS gateway associated with the communications service provider to enable a plurality of traffic designation points overlaid on the digital image of each region of interest within the traffic to be displayed with the traffic information.
